(19) United States
(12) Patent Application Publication
(10) Pub. No.: US 2015/0252214 A1
(43) Pub. Date: Sep. 10, 2015

(54) FLEXIBLE, WRINKLE RESISTANT POLY (PHENYLENE ETHER) CABLE JACKETING COMPOSITION

(71) Applicant: SABIC GLOBAL TECHNOLOGIES B.V., BERGEN OP ZOOM (NL)

(72) Inventor: Wei Shan, Shanghai (CN)

(21) Appl. No.: 14/424,086

(22) PCT Filed: Nov. 16, 2012
(86) PCT No.: PCT/CN2012/084737

§ 371 Date: Feb. 26, 2015

(51) Int. Cl. C09D 153/00; C08K 3/22; C08K 5/3462; C08L 53/00; C08K 5/5313

(52) U.S. Cl. CPC C09D 153/00; C08L 53/00; C08K 5/5313; C08K 5/3462; C08K 3/22; C08K 2003/2224; C08L 2205/03

(57) ABSTRACT

Disclosed is a flexible, wrinkle-resistant cable jacketing composition, comprising: cable jacketing compositions, comprising specific amounts of a poly(phenylene ether), a hydrogenated block copolymer of an alkenyl aromatic compound and a conjugated diene, an olefin homopolymer, a polybutene, and a flame retardant. Also disclosed are processes for making such compositions, as well as articles derived therefrom.

### FIELD OF THE INVENTION

This invention relates to jacketing compositions for cables and wire insulation based upon poly(phenylene ether).

### BACKGROUND OF THE INVENTION

In the consumer electronics market, cables are widely used for transferring data or charging power to devices. The cables are likely to be bent during the connection between different devices. As a result, it is desirable for the cables to be flexible. Some jacket materials show wrinkles on cable surfaces when cables are bent. Wrinkling is not desirable from an aesthetic standpoint, and more importantly, wrinkling is considered a failure according to the heat shock test (Underwriters Laboratory (UL) 1581). UL 1581 is an internationally recognized standard test for evaluating the fire safety for electric cables. The test is performed on cables that are tightly wrapped around a support and then are heated at 121° C. for one hour. Cable wrinkling is considered a cracking failure according to UL 1581 because wrinkles are permanently fixed during the test.

As a result, there is an ongoing need for cable jacketing compositions that are flexible and do not wrinkle.

### SUMMARY OF THE INVENTION

These and other needs are met by the present invention, which is directed to compositions of poly(phenylene ether) (PPE) and thermoplastic elastomer (TPE) for use as cable jacketing materials. In one aspect, the invention is directed to a flexible, wrinkle-resistant cable jacketing composition, comprising:
(a) 20 to 40 weight percent of a poly(phenylene ether);
(b) 25 to 50 weight percent of a hydrogenated block copolymer of an alkenyl aromatic compound and a conjugated diene;
(c) 3 to 15 percent of a polypropylene homopolymer;
(d) 5 to 15 weight percent of a polybutene; and
(e) 10 to 47 weight percent of a flame retardant;

wherein the weight percents are based on the total weight of the composition.

Surprisingly, the addition of polypropylene (PP) to PPE-TPE jacketing compositions gives rise to decreased wrinkling of jacketed cables as compared to compositions not containing PP. The PP-containing compositions of the invention generally have fewer or almost no wrinkles on the jacketed cable surface upon bending the jacketed cable. Also, increased PP loading in the compositions gives rise to less wrinkling in bent, jacketed cables.

In other aspects, the invention is directed to processes for making such compositions, as well as articles derived therefrom.

### DETAILED DESCRIPTION

All ranges disclosed herein are inclusive of the endpoints, and the endpoints can be independently combined with each other. The use of the terms “a” and “an” and “the” and similar referents in the context of describing the invention (especially in the context of claims) are to be construed to cover both their singular and plural meanings, unless otherwise indicated herein or clearly contradicted by context. It should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (that is, it includes the degree of error associated with measurement of the particular quantity). As used herein weight percents are based on the total weight of the composition.

### Components

### Poly(Phenylene Ether)

The jacketing composition comprises a poly(phenylene ether). In some embodiments, the poly(phenylene ether) used to form the jacketing composition comprises repeating structural units of the formula

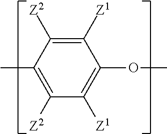

wherein for each structural unit, each Z¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

As used herein, the term “hydrocarbyl,” whether used by itself or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as “substituted,” it can contain heteroatoms over and above the carbon and hydrogen members of the substituent residue. Thus, when specifically described as substituted, the hydrocarbyl residue can also contain halogen atoms, nitro groups, cyano groups, carbonyl groups, carboxylic acid groups, ester groups, amino groups, amide groups, sulfonyl groups, sulfoxyl groups, sulfonamide groups, sulfamoyl groups, hydroxyl groups, alkoxyl groups, or the like, and it can contain heteroatoms within the backbone of the hydrocarbyl residue.

The poly(phenylene ether) can comprise molecules having aminoalkyl-containing end group(s), typically located in an ortho position to the ethane group. Also frequently present are tetramethyldiphenoquinone (TMDQ) end groups, typically obtained from reaction mixtures in which tetramethyldiphenoquinone by-product is present. In some embodiments the poly(phenylene ether) comprises TMDQ end groups in an amount of less than 5 weight percent, specifically less than 3 weight percent, more specifically less than 1 weight percent, based on the weight of the poly(phenylene ether). In some embodiments, the poly(phenylene ether) comprises, on average, about 0.7 to about 2 moles, specifically about 1 to about 1.5 moles, of chain-terminal hydroxyl groups per mole of poly(phenylene ether).

The poly(phenylene ether) can be in the form of a homopolymer, a copolymer, a graft copolymer, an ionomer, or a block copolymer, as well as combinations comprising at least one of the foregoing. Poly(phenylene ether) includes polyphenylene ether comprising 2,6-dimethyl-1,4-phenylene ether units optionally in combination with 2,3,6-trimethyl-1,4-phenylene ether units. In some embodiments, the poly(phenylene ether) is an unfunctionalized poly(phenylene ether). An unfunctionalized poly(phenylene ether) is a poly(phenylene ether) consisting of the polymerization product of one or more phenols. The term “unfunctionalized poly(phenylene ether)” excludes functionalized poly(phenylene ether)s such as acid-functionalized poly(phenylene ether)s and anhydride-functionalized poly(phenylene ether)s. In some embodiments, the poly(phenylene ether) comprises a poly(2,6-dimethyl-1,4-phenylene ether).

The poly(phenylene ether) can be prepared by the oxidative coupling of monohydroxyaromatic compound(s) such as 2,6-xylenol and/or 2,3,6-trimethylphenol. Catalyst systems are generally employed for such coupling. They can contain heavy metal compounds such as copper, manganese, or cobalt compounds, usually in combination with one or more ligands such as a primary amine, a secondary amine, a tertiary amine, a halide, or a combination of two or more of the foregoing.

In some embodiments, the poly(phenylene ether) has an intrinsic viscosity of about 0.2 to about 1.0 deciliter per gram, as measured by Ubbelohde viscometer in chloroform at 25° C. In some embodiments, the poly(phenylene ether) has an intrinsic viscosity of about 0.3 to about 0.6 deciliter per gram. When the poly(phenylene ether) is a poly(2,6-dimethyl-1,4-phenylene ether), the intrinsic viscosity range of about 0.3 to about 0.6 deciliter per gram can correspond to a number average molecular weight range of about 16,000 to about 25,000 atomic mass units.

In some embodiments, the jacketing composition comprises less than or equal to 20 weight percent, specifically less than or equal to 8 weight percent, more specifically less than or equal to 2 weight percent, 1 weight percent, or less than or equal to 0.5 weight percent, of a poly(phenylene ether)-polysiloxane block copolymer. In some embodiments, the jacketing composition excludes poly(phenylene ether)-polysiloxane block copolymer. Poly(phenylene ether)-polysiloxane block copolymers, which comprise at least one poly(phenylene ether) block and at least one polysiloxane block, are described, for example, in U.S. Pat. No. 7,847,032 (Guo et al.).

In some embodiments, the poly(phenylene ether) is essentially free of incorporated diphenoquinone residues. “Diphenoquinone residues” means the dimerized moiety that may form in the oxidative polymerization reaction giving rise to the poly(phenylene ethers) contemplated for use in the present invention. As described in U.S. Pat. No. 3,306,874 (Hay), synthesis of poly(phenylene ethers) by oxidative polymerization of monohydric phenols yields not only the desired poly(phenylene ether) but also a diphenoquinone side product. For example, when the monohydric phenol is 2,6-dimethylphenol, 3,3′,5,5′-tetramethyldiphenoquinone (TMDQ) is generated. Typically, the diphenoquinone is “re-equilibrated” into the poly(phenylene ether) (i.e., the diphenoquinone is incorporated into the poly(phenylene ether) structure) by heating the polymerization reaction mixture to yield a poly(phenylene ether) comprising terminal or internal diphenoquinone residues. As used herein, “essentially free” means that fewer than 1 weight percent of poly(phenylene ether) molecules comprise the residue of a diphenoquinone as measured by nuclear magnetic resonance spectroscopy (NMR) (Mole of TMDQ×Molecular Weight of unit TMDQ)/(Mole of Polymer×Number Average Molecular Weight (Mn)). In some embodiments, fewer than 0.5 weight percent of poly(phenylene ether) molecules comprise the residue of a diphenoquinone.

For example, as shown in the following Scheme 1, when a poly(phenylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(phenylene ether) with terminal and internal residues of incorporated diphenoquinone.

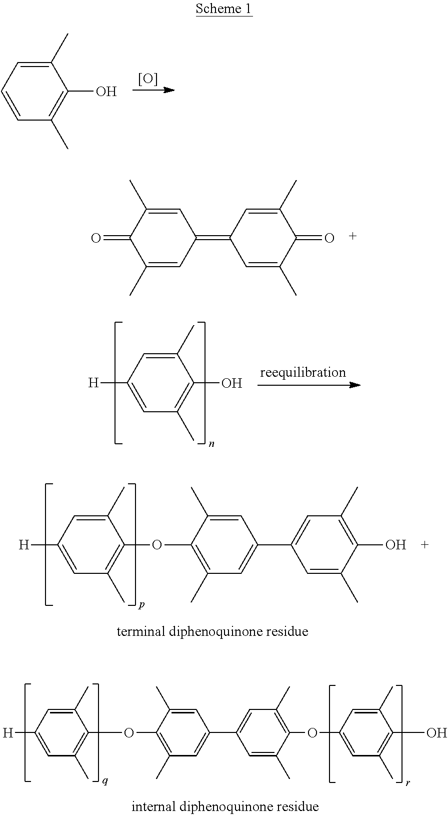

However, such re-equilibration reduces the molecular weight of the poly(phenylene ether) (e.g., p and q+r are less than n). Accordingly, when a higher molecular weight and stable molecular weight poly(phenylene ether) is desired, it may be desirable to separate the diphenoquinone from the poly(phenylene ether) rather than re-equilibrating the diphenoquinone into the poly(phenylene ether) chains. Such a separation can be achieved, for example, by precipitation of the poly(phenylene ether) in a solvent or solvent mixture in which the poly(phenylene ether) is insoluble and the diphenoquinone is soluble with very minimum time between end of reaction and precipitation.

For example, when a poly(phenylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with about 1 to about 4 volumes of methanol or methanol water mixture. Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the re-equilibration of the diphenoquinone into the poly(phenylene ether) chain can be minimized (e.g., by isolating the poly(phenylene ether) no more than 200 minutes after termination of oxidative polymerization). These approaches are described U.S. Pat. No. 8,025,158, by Delsman and Schoenmakers. Alternatively, diphenoquinone amounts can be achieved by removing the TMDQ formed during polymerization by filtration, specifically after stopping the oxygen feed into the polymerization reactor.

In some embodiments, the poly(phenylene ether) is a poly(2,6-dimethyl-1,4-phenylene ether) having an intrinsic viscosity of 0.3 to 0.6 deciliter per gram measured in chloroform at 25° C.

In some embodiments, the jacketing composition comprises about 20 to about 40 weight percent of a poly(phenylene ether). In some embodiments, the jacketing composition comprises about 20 to about 35 weight percent of a poly(phenylene ether). In some embodiments, the jacketing composition comprises about 21 to about 27 weight percent of a poly(phenylene ether). In some embodiments, the jacketing composition comprises about 20 to about 25 weight percent of a poly(phenylene ether). In some embodiments, the jacketing composition comprises about 30 to about 35 weight percent of a poly(phenylene ether).

In these and other embodiments, the poly(phenylene ether) is a poly(2,6-dimethyl-1,4-phenylene ether). In a further embodiment, the poly(phenylene ether) is a poly(2,6-dimethyl-1,4-phenylene ether) having an intrinsic viscosity of 0.3 to 0.6 deciliter per gram measured in chloroform at 25° C. In a further embodiment, the poly(phenylene ether) is a poly(2,6-dimethyl-1,4-phenylene ether) having an intrinsic viscosity of 0.4 to 0.5 deciliter per gram measured in chloroform at 25° C.

### Hydrogenated Block Copolymer

In addition to the poly(phenylene ether), the jacketing composition further comprises one or more hydrogenated block copolymers of an alkenyl aromatic compound and a conjugated diene. For conciseness, this component is referred to herein as the “hydrogenated block copolymer.”

The hydrogenated block copolymer may comprise about 10 to about 90 weight percent of poly(alkenyl aromatic) content and about 90 to about 10 weight percent of poly(conjugated diene) content. In some embodiments, the poly(alkenyl aromatic) content is about 10 to 45 weight percent, specifically about 20 to about 40 weight percent. In other embodiments, the poly(alkenyl aromatic) content is greater than 45 weight percent to about 90 weight percent, specifically about 55 to about 80 weight percent. The hydrogenated block copolymer can have a weight average molecular weight of about 40,000 to about 400,000 atomic mass units. As for the poly(phenylene ether) component, the number average molecular weight and the weight average molecular weight may be determined by gel permeation chromatography and based on comparison to polystyrene standards. In some embodiments, the hydrogenated block copolymer has a weight average molecular weight of 200,000 to about 400,000 atomic mass units, specifically 220,000 to about 350,000 atomic mass units. In other embodiments, the hydrogenated block copolymer can have a weight average molecular weight of about 40,000 to less than 200,000 atomic mass units, specifically about 40,000 to about 180,000 atomic mass units, more specifically about 40,000 to about 150,000 atomic mass units.

The alkenyl aromatic monomer used to prepare the hydrogenated block copolymer can have the structure:

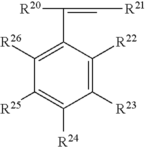

wherein R²⁰ and R²¹ each independently represent a hydrogen atom, a C₁-C₈-alkyl group, or a C₂-C₈-alkenyl group; R²² and R²⁶ each independently represent a hydrogen atom, a C₁-C₈-alkyl group, a chlorine atom, or a bromine atom; and R²³, R²⁴, and R²⁵ each independently represent a hydrogen atom, a C₁-C₈-alkyl group, or a C₂-C₈-alkenyl group, or R²³ and R²⁴ are taken together with the central aromatic ring to form a naphthyl group, or R²⁴ and R²⁵ are taken together with the carbons to which they are attached to form a naphthyl group. Specific alkenyl aromatic monomers include, for example, styrene, chlorostyrenes such as p-chlorostyrene, and methylstyrenes such as alpha-methylstyrene and p-methylstyrene. In some embodiments, the alkenyl aromatic monomer is styrene.

The conjugated diene used to prepare the hydrogenated block copolymer can be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In some embodiments, the conjugated diene is 1,3-butadiene, 2-methyl-1,3-butadiene, or a combination thereof. In some embodiments, the conjugated diene consists of 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In some embodiments, the aliphatic unsaturation in the (B) block is reduced by at least 50 percent, specifically at least 70 percent. The arrangement of blocks (A) and (B) includes a linear structure, a grafted structure, and a radial teleblock structure with or without a branched chain. Linear block copolymers include tapered linear structures and non-tapered linear structures. In some embodiments, the hydrogenated block copolymer has a tapered linear structure. In some embodiments, the hydrogenated block copolymer has a non-tapered linear structure. In some embodiments, the hydrogenated block copolymer comprises a B block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of A and B, wherein the molecular weight of each A block may be the same as or different from that of other A blocks, and the molecular weight of each B block may be the same as or different from that of other B blocks. In some embodiments, the hydrogenated block copolymer is a diblock copolymer, a triblock copolymer, or a combination thereof.

In some embodiments, the hydrogenated block copolymer is a polystyrene-poly(ethylene-butylene)-polystyrene triblock copolymer. In some embodiments, the block copolymer is a polystyrene-poly(ethylene-propylene) diblock copolymer. These hydrogenated block copolymers do not include the residue of any functionalizing agents or any monomers other than those indicated by their names.

In some embodiments, the hydrogenated block copolymer excludes the residue of monomers other than the alkenyl aromatic compound and the conjugated diene. In some embodiments, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms.

In some embodiments, the block copolymer includes the residue of one or more acid functionalizing agents, such as maleic anhydride.

Methods for preparing hydrogenated block copolymers are known in the art and many hydrogenated block copolymers are commercially available. Illustrative commercially available block copolymers include the polystyrene-poly(ethylene-propylene)diblock copolymers available from Kraton Performance Polymers, Inc. as Kraton G1701 and G1702; the polystyrene-poly(ethylene-butylene)-polystyrene triblock copolymers available from Kraton Performance Polymers, Inc. as Kraton G1641, G1650, G1651, G1652, G1654, G1657, G1726, G4609, G4610, GRP-6598, RP6924, A1636, MD6932M, MD6933, and MD6939; the polystyrene-poly(ethylene-butylene-styrene)-polystyrene (SEBS) triblock copolymers available from Kraton Polymers as Kraton A1535 and A1536; the polystyrene-poly(ethylene-propylene)-polystyrene triblock copolymers available from Kraton Performance Polymers, Inc. as Kraton G1730, A1635HU and A1636HU; the maleic anhydride-grafted polystyrene-poly(ethylene-butylene)-polystyrene triblock copolymers available from Kraton Performance Polymers, Inc. as Kraton FG1901, FG1924, and MD-6684; the maleic anhydride-grafted polystyrene-poly(ethylene-butylene-styrene)-polystyrene triblock copolymer available from Kraton Performance Polymers, Inc. as Kraton MD6670; the polystyrene-poly(ethylene-butylene)-polystyrene triblock copolymer comprising 67 weight percent polystyrene available from AK Elastomer as TUFTEC H1043; the polystyrene-poly(ethylene-butylene)-polystyrene triblock copolymer comprising 42 weight percent polystyrene available from AK Elastomer as TUFTEC H1051; the polystyrene-poly(butadiene-butylene)-polystyrene triblock copolymers available from AK Elastomer as TUFTEC P1000 and P2000; the polystyrene-polybutadiene-poly(styrene-butadiene)-polybutadiene block copolymer available from AK Elastomer as S.O.E.-SS L601; the radial block copolymers available from Chevron Phillips Chemical Company as K-Resin KK38, KR01, KR03, and KR05; the polystyrene-poly(ethylene-butylene)-polystyrene triblock copolymer comprising about 60 weight polystyrene available from Kuraray as SEPTON S8104; the polystyrene-poly(ethylene-ethylene/propylene)-polystyrene triblock copolymers available from Kuraray as SEPTON S4044, S4055, S4077, and S4099; and the polystyrene-poly(ethylene-propylene)-polystyrene triblock copolymer comprising about 65 weight percent polystyrene available from Kuraray as SEPTON S2104. Mixtures of two of more block copolymers may be used.

In some embodiments, at least a portion of the hydrogenated block copolymer is provided in the form of a melt-kneaded blend comprising hydrogenated block copolymer, an ethylene-propylene copolymer, and mineral oil, such as, for instance TPE-SB2400, from Sumitomo. In this context, the term “melt-kneaded blend” means that the hydrogenated block copolymer, the ethylene-propylene copolymer, and the mineral oil are melt-kneaded with each other before being melt-kneaded with other components. The ethylene-propylene copolymer in this melt-kneaded blend is an elastomeric copolymer (that is, a so-called ethylene-propylene rubber (EPR)). Suitable ethylene-propylene copolymers are described below in the context of the optional ethylene/alpha-olefin copolymer. In these blends, the hydrogenated block copolymer amount may be about 20 to about 60 weight percent, specifically about 30 to about 50 weight percent; the ethylene-propylene copolymer amount may be about 2 to about 20 weight percent, specifically about 5 to about 15 weight percent; and the mineral oil amount may be about 30 to about 70 weight percent, specifically about 40 to about 60 weight percent; wherein all weight percents are based on the total weight of the melt-kneaded blend.

In some embodiments, the jacketing composition comprises about 25 to about 50 total weight percent of one or more hydrogenated block copolymers, based on the total weight of the jacketing composition, preferably about 25 to about 44 weight percent and more preferably about 37 to about 39 weight percent.

In some embodiments, the jacketing composition comprises a mixture of a polystyrene-poly(ethylene-butylene-styrene)-polystyrene (SEBS) triblock copolymer and a melt kneaded blend comprising hydrogenated block copolymer, an ethylene-propylene copolymer, and mineral oil or a linear triblock copolymer based on styrene and ethylene/butylene, SEBS. In these and other embodiments, the composition comprises approximately 20 to 28 weight percent of a polystyrene-poly(ethylene-butylene-styrene)-polystyrene (SEBS) triblock copolymer; and either of 10 to 18 percent of a melt kneaded blend comprising hydrogenated block copolymer, an ethylene-propylene copolymer, and mineral oil; or 6 to 16 weight percent of a linear triblock copolymer based on styrene and ethylene/butylene, SEBS.

In one embodiment, the jacketing composition comprises a mixture of a polystyrene-poly(ethylene-butylene-styrene)-polystyrene (SEBS) triblock copolymer (such as Kraton A1535 or A1536) and either of a melt-kneaded blend (such as TPE-SB2400) from Sumitomo Chemical, or a linear triblock copolymer based on styrene and ethylene/butylene, SEBS (such as Kraton G1652.

### Polyolefin Homopolymer

In addition to the poly(phenylene ether) and hydrogenated block copolymer, the jacketing composition of the present invention may further comprise one or more polyolefin homopolymers. The polyolefin homopolymer may be selected from the group consisting of polyethylene (PE), polypropylene (PP), and polyisobutene (PIB). Polybutene, which may be a homopolymer or copolymer, is described below. Thus, the term “polyethylene homopolymer” means a homopolymer of ethylene. The term “polypropylene homopolymer” means a homopolymer of propylene. The term “polybutene homopolymer” means a homopolymer of butylene as discussed above. The term “polyisobutene homopolymer” means a homopolymer of polyisobutene.

In one embodiment, the polyolefin homopolymer is propylene homopolymer which is present in an amount of about 3 to about 15 weight percent based on the total weight of the jacketing composition. In another embodiment, the polyolefin homopolymer is propylene homopolymer which is present in an amount of about 4 to about 10 weight percent based on the total weight of the jacketing composition. In another embodiment, the polyolefin homopolymer is propylene homopolymer which is present in an amount of about 4 to about 8 weight percent based on the total weight of the jacketing composition. In another embodiment, the polyolefin homopolymer is polypropylene homopolymer, CAS Reg. No. 9003-07-0, available from SABIC Innovative Plastics as 570P present in an amount of about 7 to about 8 weight percent based on the total weight of the jacketing composition.

### Polybutene

In addition to the poly(phenylene ether) and hydrogenated block copolymer, and polypropylene homopolymer, the jacketing composition of the present invention further comprises a polybutene. As used herein, the term “polybutene” refers to a polymer comprising greater than 75 weight percent of units, specifically greater than 80 weight percent of units, derived from 1-butene, 2-butene, 2-methylpropene (isobutene), or a combination thereof. The polybutene may be a homopolymer (as described below) or a copolymer. In some embodiments, the polybutene consists of units derived from 1-butene, 2-butene, 2-methylpropene (isobutene), or a combination thereof. In other embodiments, the polybutene is a copolymer that comprises 1 to less than 25 weight percent of a copolymerizable monomer such as ethylene, propylene, or 1-octene.

In one embodiment, the polybutene is a homopolymer. In another embodiment, the polymer is a copolymer of isobutylene and 1-butene or 2-butene. In another embodiment, the polybutene is a mixture comprising polybutene homopolymer and polybutene copolymer.

In one embodiment, the jacketing composition of the present invention comprises about 5 to about 15 weight percent of a polybutene based on the total weight of the jacketing composition. In another embodiment, the jacketing composition of the present invention comprises about 5 to about 10 weight percent of a polybutene based on the total weight of the jacketing composition and preferably about 7 to about 9 weight percent of a polybutene based on the total weight of the jacketing composition.

In another embodiment, the polybutene is a copolymer wherein the isobutylene derived units are from 40 to 99 weight percent of the copolymer, the 1-butene derived units are from 2 to 40 weight percent of the copolymer, and the 2-butene derived units are from 0 to 30 weight percent of the copolymer. In yet another embodiment, the polybutene is a terpolymer of the three units, wherein the isobutylene derived units are from 40 to 96 weight percent of the copolymer, the 1-butene derived units are from 2 to 40 weight percent of the copolymer, and the 2-butene derived units are from 2 to 20 weight percent of the copolymer. In yet another embodiment, the polybutene is a copolymer of isobutylene and 1-butene, wherein the isobutylene derived units are from 65 to 100 weight percent of the homopolymer or copolymer, and the 1-butene derived units are from 0 to 35 weight percent of the copolymer.

In another embodiment, the polybutene is a copolymer that comprises 1 to less than 25 weight percent of a copolymerizable monomer such as ethylene, propylene, or 1-octene. In some embodiments, the polybutene has a number average molecular weight of about 700 to about 1,000 atomic mass units. Suitable polybutenes include, for example, the isobutene-butene copolymer having a number average molecular weight of about 800 atomic mass units such as Indopol HSO.

In another embodiment, the jacketing composition comprises a liquid polybutene having a number average molecular weight of about 800 AMU. In a further embodiment, the polybutene is Indopol HSO from INEOS Oligomers. In a further embodiment, the jacketing composition comprises about 5 to about 15 weight percent of Indopol HSO and preferably, about 5 to about 10 weight percent of Indopol HSO based on the total weight of the jacketing composition.

### Flame Retardant

In addition to the poly(phenylene ether), hydrogenated block copolymer, polypropylene homopolymer, and polybutene, the jacketing composition comprises one or more flame retardants. There is no particular restriction on the types of flame retardants that may be used except that the flame retardant is suitably stable at the elevated temperatures employed during processing. Exemplary flame retardants include melamine (CAS No. 108-78-1), melamine cyanurate (CAS No. 37640-57-6), melamine phosphate (CAS No. 20208-95-1), melamine pyrophosphate (MPP) (CAS No. 15541-60-3), melamine polyphosphate (CAS No. 218768-84-4), melam, melem, melon, zinc borate, polyphosphazine, (CAS No. 1332-07-6), boron phosphate, red phosphorous (CAS No. 7723-14-0), organophosphate esters, monoammonium phosphate (CAS No. 7722-76-1), diammonium phosphate (CAS No. 7783-28-0), alkyl phosphonates (CAS No. 78-38-6 and 78-40-0), metal dialkyl phosphinate, ammonium polyphosphates (CAS No. 68333-79-9), low melting glasses and combinations of two or more of the foregoing flame retardants.

Exemplary organophosphate ester flame retardants include, but are not limited to, phosphate esters comprising phenyl groups, substituted phenyl groups, or a combination of phenyl groups and substituted phenyl groups, bis-aryl phosphate esters based upon resorcinol such as, for example, resorcinol bis-diphenylphosphate, as well as those based upon bis-phenols such as, for example, bis-phenol A bis-diphenylphosphate (BPADP). In one embodiment, the organophosphate ester is selected from tris(alkylphenyl) phosphate (for example, CAS Reg. No. 89492-23-9 or CAS Reg. No. 78-33-1), resorcinol bis-diphenylphosphate (for example, CAS Reg. No. 57583-54-7), bis-phenol A bis-diphenylphosphate (for example, CAS Reg. No. 181028-79-5), triphenyl phosphate (for example, CAS Reg. No. 115-86-6), tris(isopropylphenyl) phosphate (for example, CAS Reg. No. 68937-41-7), triphenyl phosphate (CAS Reg. No. 115-86-6) and mixtures of two or more of the foregoing organophosphate esters.

In some embodiments, the flame retardant comprises one or more of a phosphoric acid salt, a metal dialkyl phosphinate, a nitrogen-containing flame retardant, a metal hydroxide, and a triaryl phosphate. The flame retardant composition has the advantage of providing excellent flame retardance at lower levels of organic phosphate than organic phosphate alone, thus decreasing or eliminating plate-out and migration in thermoplastic jacketing compositions.

In some embodiments, the flame retardant additive jacketing composition consists essentially of (A) a phosphoric acid salt such as melamine phosphate, melamine pyrophosphate, melamine orthophosphate, melamine polyphosphate, diammonium phosphate, monoammonium phosphate, phosphoric acid amide, ammonium polyphosphate, polyphosphoric acid amide, and combinations of two or more of the foregoing; (B) a metal hydroxide; and (C) an organic phosphate. “Consisting essentially of” as used herein allows the inclusion of additional components as long as those additional components do not materially affect the basic and novel characteristics of the flame retardant additive, such as the ability to provide the same or greater level of flame retardance to a thermoplastic jacketing composition at lower levels of organic phosphate than organic phosphate alone and/or being essentially free (containing less than 0.05 weight percent, or, more specifically less than 0.005 weight percent, based on the combined weight of phosphoric acid salt, metal hydroxide and organic phosphate) of chlorine and bromine.

In another embodiment, the flame retardant additive jacketing composition consists of (A) a phosphoric acid salt selected from the group consisting of melamine phosphate, melamine pyrophosphate, melamine orthophosphate, melem polyphosphate, melam polyphosphate, diammonium phosphate, monoammonium phosphate, phosphoric acid amide, melamine polyphosphate, ammonium polyphosphate, polyphosphoric acid amide, and combinations of two or more of the foregoing; (B) a metal hydroxide; and (C) an organic phosphate.

In one embodiment, the jacketing composition comprises about 10 to about 47 by weight percent of total flame retardant based on the total weight of the jacketing composition. In another embodiment, the jacketing composition comprises about 10 to about 30 weight percent of total flame retardant based on the total weight of the jacketing composition.

In one embodiment, the flame retardant comprises BPADP alone or in combination with another flame retardant.

In another embodiment, the flame retardant comprises BPADP and MPP. In another embodiment, the flame retardant comprises BPADP, MPP, and Mg(OH)₂. In another embodiment, the flame retardant comprises BPADP, MPP, and aluminum tris(diethyl phosphinate) (AIP). In another embodiment, the flame retardant comprises MPP and aluminum tris(diethyl phosphinate) (AIP).

In another embodiment, the flame retardant comprises BPADP, MPP, and Mg(OH)₂. In this and other embodiments, approximately 8 to 12 weight percent of BPADP, 2.5 to 7.5 weight percent of MPP, and 2.5 to 5 weight percent of Mg(OH)₂ are present, based on the total weight of the composition. More particularly, approximately 9 to 11 weight percent of BPADP, 3.5 to 7.0 weight percent of MPP, and 3 to 4.5 weight percent of Mg(OH)₂ are present, based on the total weight of the composition.

In another embodiment, the flame retardant comprises BPADP, MPP, and aluminum tris(diethyl phosphinate) (AIP). In this and other embodiments, approximately 8 to 12 weight percent of BPADP, 3 to 7 weight percent of MPP, and 3 to 7 weight percent of AIP are present, based on the total weight of the composition. More particularly, approximately 9 to 11 weight percent of BPADP, 4 to 6 weight percent of MPP, and 4 to 6 weight percent of AIP are present, based on the total weight of the composition.

In another embodiment, the flame retardant comprises MPP alone or in combination with aluminum tris(diethyl phosphinate) (AIP). In this and other embodiments, approximately 5 to 10 weight percent of BPADP, and 5 to 10 weight percent of AIP are present, based on the total weight of the composition. More particularly, approximately 6 to 9 weight percent of MPP and 6 to 9 weight percent of AIP are present, based on the total weight of the composition.

Other flame retardants that can be used to practice the invention are provided below.

Phosphoric Acid Salts

In some embodiments, the flame retardant comprises one or more phosphoric acid salts.

As mentioned above, the phosphoric acid salt can be selected from the group consisting of melamine phosphate (for example, CAS No. 20208-95-1), melamine pyrophosphate (for example, CAS No. 15541-60-3), melem polyphosphate, melam polyphosphate, melamine orthophosphate (for example, CAS No. 20208-95-1), monoammonium phosphate (for example, CAS No. 7722-76-1), diammonium phosphate (for example, CAS No. 7783-28-0), phosphoric acid amide (for example, CAS No. 680-31-9), melamine polyphosphate (for example, CAS No. 218768-84-4 or 56386-64-2), ammonium polyphosphate (for example, CAS No. 68333-79-9), polyphosphoric acid amide and combinations of two or more of the foregoing phosphoric acid salts. The phosphoric acid salt can be surface coated with one or more of compounds selected from melamine monomer, melamine resin, modified melamine resin, guanamine resin, epoxy resin, phenol resin, urethane resin, urea resin, silicone resin, and the like. The identity of the surface coating, when present, is typically chosen based upon the identity of the thermoplastic components of the flame retardant thermoplastic jacketing composition. In some embodiments the phosphoric acid salt comprises melamine polyphosphate. In some embodiments the phosphoric acid salt comprises a combination of melamine polyphosphate and melamine phosphate.

Phosphoric acid salts are commercially available or can be synthesized by the reaction of a phosphoric acid with the corresponding amine containing compound as is taught in the art.

Metal Hydroxides

In some embodiments, the flame retardant comprises one or more metal hydroxides. Suitable metal hydroxides include all those capable of providing fire retardance, as well as combinations thereof. The metal hydroxide can be chosen to have substantially no decomposition during processing of the fire additive jacketing composition and/or flame retardant thermoplastic jacketing composition. Substantially no decomposition is defined herein as amounts of decomposition that do not prevent the flame retardant additive jacketing composition from providing the desired level of fire retardance. Exemplary metal hydroxides include, but are not limited to, magnesium hydroxide (for example, CAS No. 1309-42-8), aluminum hydroxide (for example, CAS No. 21645-51-2), cobalt hydroxide (for example. CAS No. 21041-93-0) and combinations of two or more of the foregoing. In some embodiments, the metal hydroxide comprises magnesium hydroxide. In some embodiments the metal hydroxide has an average particle size less than or equal to 10 micrometers and/or a purity greater than or equal to 90 weight percent. In some embodiments it is desirable for the metal hydroxide to contain substantially no water, i.e. a weight loss of less than 1 weight percent upon drying at 120° C. for 1 hour. In some embodiments the metal hydroxide can be coated, for example, with stearic acid or other fatty acids. In other embodiments, the metal hydroxide is coated with an aminosilane.

Organic Phosphates

In some embodiments, the flame retardant comprises one or more organic phosphate.

The organic phosphate can be an aromatic phosphate compound of the formula:

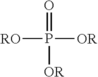

where each R is independently an alkyl, cycloalkyl, aryl, alkyl substituted aryl, halogen substituted aryl, aryl substituted alkyl, halogen, or a combination of any of the foregoing, provided at least one R is aryl or alkyl substituted aryl.

Examples include phenyl bisdodecyl phosphate, phenylbisneopentyl phosphate, phenyl-bis(3,5,5′-tri-methyl-hexyl phosphate), ethyldiphenyl phosphate, 2-ethyl-hexyldi(p-tolyl)phosphate, bis-(2-ethylhexyl)p-tolylphosphate, tritolyl phosphate, bis-(2-ethylhexyl)phenyl phosphate, tri-(nonylphenyl)phosphate, di(dodecyl)p-tolyl phosphate, tricresyl phosphate, triphenyl phosphate, dibutylphenyl phosphate, 2-chloroethyldiphenyl phosphate, p-tolyl bis(2,5,5′-trimethylhexyl)phosphate, 2-ethylhexyldiphenyl phosphate, and the like. In some embodiments the phosphate is one in which each R is aryl and/or alkyl substituted aryl, such as triphenyl phosphate and tris(alkyl phenyl)phosphate.

Alternatively, the organic phosphate can be a di- or polyfunctional compound or polymer having one of the following formulas:

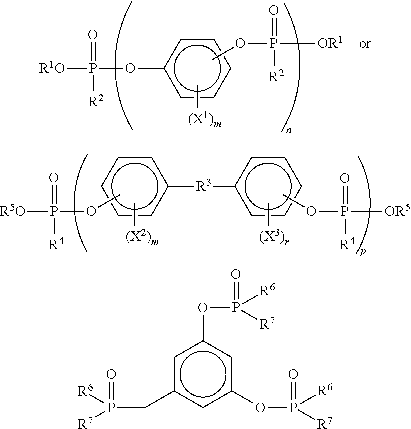

including mixtures thereof, in which R¹, R³ and R⁵ are, independently, hydrocarbon; R², R⁴, R⁶ and R⁷ are, independently, hydrocarbon or hydrocarbonoxy; X¹, X² and X³ are, independently, halogen; m and r are 0 or integers from 1 to 4, and n and p are from 1 to 30.

Examples include the bis diphenyl phosphates of resorcinol, hydroquinone and bisphenol-A, respectively, or their polymeric counterparts. Methods for the preparation of the aforementioned di- and polyfunctional aromatic phosphates are described in British Patent No. 2,043,083.

Exemplary organic phosphates include, but are not limited to, phosphates containing substituted phenyl groups, phosphates based upon resorcinol such as, for example, resorcinol bis-diphenylphosphate, as well as those based upon bis-phenols such as, for example, bis-phenol A bis-diphenylphosphate. In some embodiments, the organic phosphate is selected from tris(butyl phenyl)phosphate (for example, CAS No. 89492-23-9, and 78-33-1), resorcinol bis-diphenylphosphate (for example, CAS No. 57583-54-7), bis-phenol A bis-diphenylphosphate (for example, CAS No. 181028-79-5), triphenyl phosphate (for example, CAS No. 115-86-6), tris(isopropyl phenyl)phosphate (for example, CAS No. CAS No. 68937-41-7) and mixtures of two or more of the foregoing.

Phosphinate and Phosphonate Salts

In some embodiments, the flame retardant comprises one or more metal salts of phosphinates and phosphonates (so-called “metallophophorous” flame retardants). The metal component of the metal phosphinate or phosphonate salt can be a cation of Mg, Ca, Al, Sb, Sn, Ge, Ti, Zn, Fe, Zr, Ce, Bi, Sr, Mn, Li, Na, or K. The phosphinate or phosphonate component can be dimethylphosphinate, diethylphosphinate, di-n-propylphosphinate, di-n-butylphosphinate, di-n-hexylphosphinate, dicyclohexylphosphinate, di-2-ethylhexylphosphinate, diphenylphosphinate, di-o-tolylphosphinate, dimethylphosphonate, diethylphosphonate, di-n-propylphosphonate, di-n-butylphosphonate, di-n-hexylphosphonate, dicyclohexylphosphonate, di-2-ethylhexylphoshate, diphenylphosphonate, di-o-tolylphosphonate, dimethylphosphate, diethylphosphate, di-n-propylphosphate, di-n-butylphosphate, di-n-hexylphosphate, dicyclohexylphosphate, di-2-ethylhexylphoshate, diphenylphosphate, di-o-tolylphosphate, and the like, and mixtures thereof. A preferred metallophosphorus flame retardant is aluminum tris(diethylphosphinate). Preparation of metallophosphorus flame retardants is described, for example, in U.S. Pat. Nos. 6,255,371 and 6,547,992 to Schlosser et al., and U.S. Pat. Nos. 6,355,832 and 6,534,673 to Weferling et al.

Some of the above described components of the flame retardant additive jacketing composition are in liquid form at room temperature (25° C.) and some are solid.

### Anti-Ultraviolet Radiation Agent

In addition to the poly(phenylene ether), hydrogenated block copolymer, polybutene, and flame retardant, the jacketing composition may optionally further comprise an agent that protects the jacketing composition from UV degradation, referred to herein as an “anti-UV agent.”

In one embodiment, the jacketing compositions of the present invention may contain a benzotriazole-type UV absorber as the anti-UV agent, which are compounds with a benzotriazole core

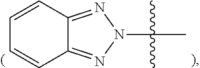 [SMILES: *n1nc2ccccc2n1]

such as those shown below.

| Structure | Name |
|---|---|
| 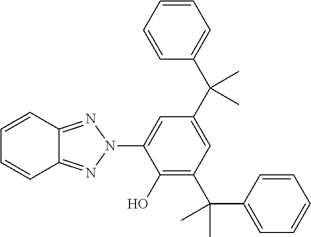 [SMILES: CC(C)(c1ccccc1)c1cc(-n2nc3ccccc3n2)c(O)c(C(C)(C)c2ccccc2)c1] | 2-(2H-benzotriazol-2-yl)-4,6-bis(1- methyl-1-phenylethyl)phenol CAS Reg. No. 70321-86-7 Tinuvin 234 |
| 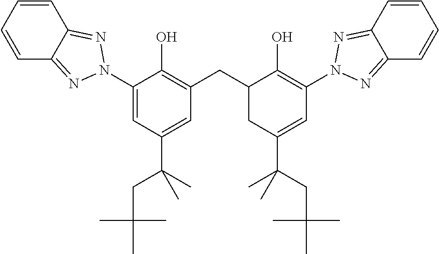 [SMILES: CC(C)(C)CC(C)(C)C1=CC(n2nc3ccccc3n2)=C(O)C(Cc2cc(C(C)(C)CC(C)(C)C)cc(-n3nc4ccccc4n3)c2O)C1] | 2,2′-Methylene bis(6-(2H-benzotriazol-2- yl)-4-,1,1,3,3,tetramethylbutyl)phenol) CAS Reg. No. 103597-45-1 Chiguard 5431 |

In another embodiment, the jacketing compositions of the present invention may contain other anti-UV agents that are known in the art, including trisaryl-1,3,5-triazine UV absorber which are compounds that have a triazine core

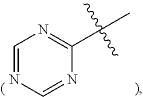 [SMILES: *c1ncncn1]

as in the following compounds.

| Structure | Name |
|---|---|
| 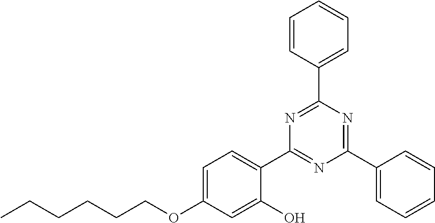 [SMILES: CCCCCCOc1ccc(-c2nc(-c3ccccc3)nc(-c3ccccc3)n2)c(O)c1] | 2-(4,6-Diphenyl-1,3,5-triazin-2-yl)-5- hexyloxy-phenol CAS Reg. No. 147315-50-2 Tinuvin 1577 |
| 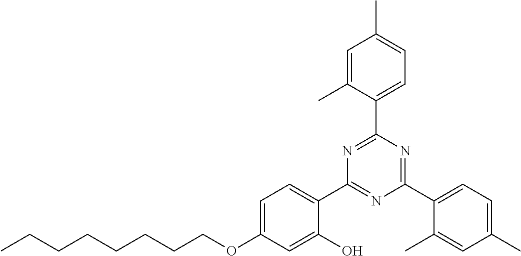 [SMILES: CCCCCCCCOc1ccc(-c2nc(-c3ccc(C)cc3C)nc(-c3ccc(C)cc3C)n2)c(O)c1] | 2-[4,6-Bis(2,4-dimethylphenyl)-1,3,5- triazin-2-yl]-5-(octyloxy)pheno1 CAS Reg. No. 2725-22-6 Chiguard 1064 |

Other anti-UV agents known in the art include the UV absorber pentaerythritoltetrakis(2-cyano-3,3-diphenylacrylate, cycloaliphatic epoxy UV stabilizers and hindered amine light stabilizers (HALS). The structure of pentaerythritoltetrakis(2-cyano-3,3-diphenylacrylate is shown below.

| Structure | Name |
|---|---|
| 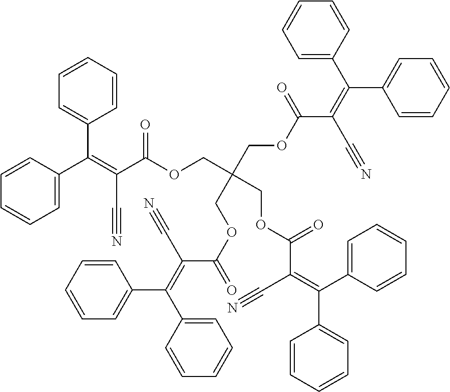 [SMILES: N#CC(C(=O)OCC(COC(=O)C(C#N)=C(c1ccccc1)c1ccccc1)(COC(=O)C(C#N)=C(c1ccccc1)c1ccccc1)COC(=O)C(C#N)=C(c1ccccc1)c1ccccc1)=C(c1ccccc1)c1ccccc1] | Pentaerythritol tetrakis(2-cyano-3,3- diphenylacrylate) CAS Reg. No. 147315-50-2 Uvinul 3030 |

Cycloaliphatic epoxy compounds that are UV-stabilizers include, for example, cyclopentene oxide, cyclohexene oxide, 4-vinylcyclohexene oxide, 4-vinylcyclohexene dioxide, 3,4-epoxycyclohexylmethyl 3′,4′-epoxycyclohexylcarboxylate (CAS Reg. No. 2386-87-0, available from Daicel as Celloxide 2021P), 4-alkoxymethylcyclohexene oxides, acyloxymethylcyclohexene oxides, 1,3-bis(2-(3,4-epoxycyclohexyl)ethyl)-1,1,3,3-tetramethydisiloxane, 2-epoxy-1,2,3,4-tetrahydronaphthalene, and the like.

HALS anti-UV agents include poly(4-hydroxy-2,2,6,6-tetramethyl-1-piperidine ethanol-alt-1,4-butanedioic acid), along with several other HALS stabilizers, the structures of which are depicted below.

| Structure | Name |
|---|---|
| 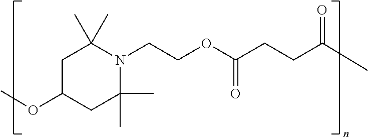 | 4-Hydroxy-2,2,6,6-tetramethyl-1- piperidinethanol-dimethyl succinate copolymer Also known as poly(4-hydroxy-2,2,6,6- tetramethyl-1-piperidine ethanol-alt-1,4- butanedioic acid) CAS Reg. No. 103597-45-1 Tinuvin 622LD, Chiguard 622LD |
| 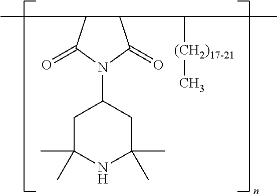 | Poly-{3-(eicosyltetracosyl)-1-[2,2,6,6- tetramethylpiperidin-4-yl]-pyrrolidine- 2,5-dione} CAS Reg. No. 152261-33-1 Uvinul 5050H |
| 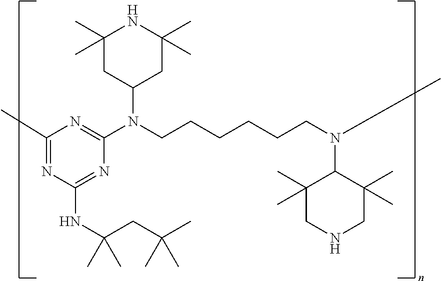 | Poly-{[6-[(1,1,3,3- tetramethylbutyl)amino]-1,3,5-triazine- 2,4-diyl] CAS Reg. No. 71878-19-8, 70624-18-9 Chimassorb 944 |
| 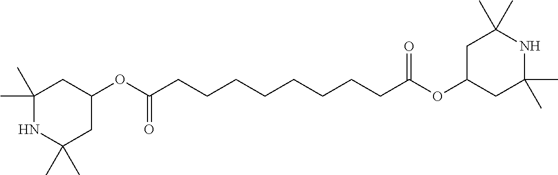 | Bis (2,2,6,6,-tetramethyl-4-piperidyl) sebacate CAS Reg. No. 52829-07-09 Tinuvin 770 |

In another embodiment, the anti-UV agent is an agent selected from several classes of ultraviolet radiation stabilizers, including triazine-type UV agents, benzophenone-type UV absorbers (including 2-hydroxybenzophenones and hydroxyphenylbenzophenones), hindered amine light stabilizers, cinnamate-type UV absorbers, oxanilide-type UV absorbers, benzoxazinone-type UV absorbers, cycloaliphatic epoxy compounds, phosphite compounds, and the like. Additional classes of ultraviolet radiation stabilizers are described in H. Zweifel, Ed., “Plastics Additive Handbook,” 5th Edition, Cincinnati: Hanser Gardner Publications, Inc. (2001), pages 206-238. In one embodiment, 0.1 to 5 weight percent of the anti-UV agent is used based on the total weight of the composition.

In one embodiment, the anti-UV agent is a benzotriazole-type anti-UV agent. In this and other embodiments, the anti-UV agent is Tinuvin 234, used alone or in combination with another anti-UV agent. In this and other embodiments, Tinuvin 234 is present in an amount of 0.6 to 1.0 weight percent based on the total weight of the composition. In another embodiment, the anti-UV agent is a cycloaliphatic epoxy compound or a hindered amine light stabilizer. In one embodiment, the cycloaliphatic epoxy compound is Celloxide 2021. In one embodiment 0.2 weight percent to 0.5 weight percent of Celloxide 2021 is present. In another embodiment, the anti-UV agent is a hindered amine light stabilizer (HALS). In one embodiment, the HALS is Uvinul 5050H. In one embodiment 0.8 weight percent to 1.1 weight percent of Uvinul 5050H is present. In another embodiment, the composition comprises a mixture of anti-UV agents. In one embodiment, the mixture of anti-UV agent comprises a benzotriazole-type UV agent, a HALS, and a cycloaliphatic epoxy compound, present in 1-3 weight percent based on the total weight of the composition. In this and other embodiments, approximately equivalent weight percents of the anti-UV agents are used.

### Colorants

The cable jacketing compositions of the present invention may optionally include one or more colorants. Colorants suitable for jacketing compositions of the present invention include pigments and/or dyes. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or combinations comprising at least one of the foregoing pigments. Pigments are generally used in amounts of 0.001 to 3 parts by weight, based on 100 parts by weight of polycarbonate and any additional polymer.

Exemplary dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly(C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; ethane dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or combinations comprising at least one of the foregoing dyes. Dyes are generally used in amounts of 0.0001 to 5 parts by weight, based on 100 parts by weight based on the total weight of the jacketing composition.

In one embodiment, the colorant is a white pigment. The white pigment contributes to the white or off-white color of the jacketing composition. Suitable white pigments include, for example, calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, modified alumina, lithopone, zeolite, hydrated halloysite, magnesium carbonate, magnesium hydroxide, and mixtures thereof. In some embodiments, the white pigment is zinc sulfide, titanium dioxide (including rutile titanium dioxide), or a mixture thereof. In some embodiments, the white pigment is titanium dioxide.

The jacketing composition comprises white pigment in an amount of about 0.5 to about 25 weight percent, based on the total weight of the jacketing composition. Within this range, the white pigment can be titanium dioxide in an amount of about 4 to about 20 weight percent, based on the total weight of the jacketing composition.

In another embodiment, the colorant comprises a mixture of colorants. The mixture of colorants may include a white pigment such as TiO₂ and one or more additional colorants. In one embodiment the colorant comprises TiO₂ carbon black, Pigment Blue 29 and Pigment Red 101, and optionally one or more additional colorants. In this embodiment, the total amount of the colorant is about 4 to about 20 weight percent, based on the total weight of the jacketing composition. In another embodiment the colorant comprises TiO₂, carbon black, Pigment Blue 29, Pigment Yellow 119, and Pigment Red 101, or mixtures thereof.

### Other Additives

In addition to the other components, the cable jacketing composition comprises a plasticizer. As used herein, the term “plasticizer” refers to a compound that is effective to plasticize the jacketing composition as a whole or at least one component of the jacketing composition. In some embodiments, the plasticizer is effective to plasticize the poly(phenylene ether). The plasticizers are typically low molecular weight, relatively nonvolatile molecules that dissolve in a polymer, separating the chains from each other and hence facilitating reptation and reducing the glass transition temperature of the jacketing composition. In some embodiments, the plasticizer has a glass transition temperature (T_{g}) of about −110 to −50° C., is miscible primarily with poly(phenylene ether)resin, and has a molecular weight less than or equal to 1,000 grams per mole.

Suitable plasticizers include, for example, benzoate esters (including dibenzoate esters), pentaerythritol esters, triaryl phosphates (including halogen substituted triaryl phosphates), phthalate esters, trimellitate esters, pyromellitate esters, and the like, and mixtures thereof.

In some embodiments, the plasticizer is a triaryl phosphate. Suitable triaryl phosphates include those having the structure

The jacketing composition may, optionally, further comprise one or more other additives known in the thermoplastics arts. Useful additives include, for example, stabilizers, mold release agents, processing aids, drip retardants, nucleating agents, dyes, pigments, antioxidants, anti-static agents, blowing agents, metal deactivators, antiblocking agents, nanoclays, fragrances (including fragrance-encapsulated polymers), and the like, and combinations thereof. Additives can be added in amounts that do not unacceptably detract from the desired appearance and physical properties of the jacketing composition. Such amounts can be determined by a skilled artisan without undue experimentation.

In some embodiments, the jacketing composition can exclude or be substantially free of components other than those described above. For example, the jacketing composition can be substantially free of other polymeric materials, such as homopolystyrenes (including syndiotactic polystyrenes), polyamides, polyesters, polycarbonates, and polypropylene-graft-polystyrenes. In this context, the term “substantially free” means that none of the specified component is intentionally added.

As the jacketing composition is defined as comprising multiple components, it will be understood that each component is chemically distinct, particularly in the instance that a single chemical compound may satisfy the definition of more than one component.

### Jacketing Composition

In one aspect, the invention provides a jacketing composition, comprising:
(a) 20 to 40 weight percent of a poly(phenylene ether);
(b) 25 to 50 weight percent of a hydrogenated block copolymer of an alkenyl aromatic compound and a conjugated diene;
(c) 3 to 15 percent of a polypropylene homopolymer;
(d) 5 to 15 weight percent of a polybutene; and
(e) 10 to 47 weight percent of a flame retardant;

In this and other aspects, the poly(phenylene ether) is a poly(2,6-dimethyl-1,4-phenylene ether) having an intrinsic viscosity of 0.3 to 0.6 deciliter per gram measured in chloroform at 25° C. In another embodiment of this aspect, the poly(phenylene ether) is a poly(2,6-dimethyl-1,4-phenylene ether) having an intrinsic viscosity of 0.4 to 0.5 deciliter per gram measured in chloroform at 25° C. In one embodiment, 20 to 25 weight percent of poly(phenylene ether) is used based on the total weight of the composition. In one embodiment, 30 to 35 weight percent of poly(phenylene ether) is used based on the total weight of the composition. In one embodiment, the jacketing composition comprises 20 to 35 weight percent of poly(2,6-dimethyl-1,4-phenylene ether) having an intrinsic viscosity of 0.4 to 0.5 deciliter per gram measured in chloroform at 25° C.

In this and other aspects, the hydrogenated block copolymer of an alkenyl aromatic compound and a conjugated diene comprises a polystyrene-poly(ethylene-butylene-styrene)-polystyrene (SEBS) triblock copolymer such as Kraton A1535 or A1536.

In this and other aspects, the hydrogenated block copolymer of an alkenyl aromatic compound and a conjugated diene comprises a mixture of the polystyrene-poly(ethylene-butylene-styrene)-polystyrene (SEBS) triblock copolymer and a melt kneaded blend comprising hydrogenated block copolymer, an ethylene-propylene copolymer, and mineral oil. In one embodiment, the melt-kneaded blend is TPE-SB2400 from Sumitomo Chemical Co which comprises about 40 weight percent polystyrene-poly(ethylene-butylene)-polystyrene, about 10 weight percent ethylene-propylene rubber, and about 50 weight percent mineral oil.

In another embodiment, the jacketing composition comprises a mixture of a polystyrene-poly(ethylene-butylene-styrene)-polystyrene (SEBS) triblock copolymer (such as Kraton A1535 or A1536) and a linear triblock copolymer based on styrene and ethylene/butylene, SEBS, with bound styrene of 30% mass, available from Kraton Performance Polymers, Inc. as G1652.

In one embodiment, the jacketing composition comprises 25 to 45 weight percent hydrogenated block copolymer of an alkenyl aromatic compound and a conjugated diene. In one embodiment, the jacketing composition comprises 25 to 45 weight percent of a mixture of a polystyrene-poly(ethylene-butylene-styrene)-polystyrene (SEBS) triblock copolymer and a melt kneaded blend comprising hydrogenated block copolymer, an ethylene-propylene copolymer, and mineral oil or a linear triblock copolymer based on styrene and ethylene/butylene, SEBS.

In some embodiments, the jacketing composition comprises a mixture of a polystyrene-poly(ethylene-butylene-styrene)-polystyrene (SEBS) triblock copolymer and a melt kneaded blend comprising hydrogenated block copolymer, an ethylene-propylene copolymer, and mineral oil or a linear triblock copolymer based on styrene and ethylene/butylene, SEBS. In these and other embodiments, the composition comprises approximately 20 to 28 weight percent of a polystyrene-poly(ethylene-butylene-styrene)-polystyrene (SEBS) triblock copolymer and 10 to 18 percent of a melt kneaded blend comprising hydrogenated block copolymer, an ethylene-propylene copolymer, and mineral oil or 6 to 16 weight percent of a linear triblock copolymer based on styrene and ethylene/butylene, SEBS.

In this and other aspects, the polyolefin homopolymer is a propylene homopolymer. In one embodiment, the polyolefin homopolymer is propylene homopolymer which is present in an amount of about 3 to about 15 weight percent based on the total weight of the jacketing composition. In another embodiment, the polyolefin homopolymer is propylene homopolymer which is present in an amount of about 4 to about 10 weight percent based on the total weight of the jacketing composition. In another embodiment, the polyolefin homopolymer is propylene homopolymer which is present in an amount of about 4 to about 8 weight percent based on the total weight of the jacketing composition. In another embodiment, the polyolefin homopolymer is polypropylene homopolymer, CAS Reg. No. 9003-07-0, available from SABIC Innovative Plastics as 570P present in an amount of about 7 to about 8 weight percent based on the total weight of the jacketing composition.

In this and other aspects, the polybutene is a liquid polyisobutene having a number average molecular weight of about 800 AMU. In one embodiment, the jacketing composition comprises 5 to 15 weight percent, and more preferably 10 to 15 weight percent of the polybutene. In some embodiments, the polybutene is Indopol HSO from INEOS Oligomers.

In this and other aspects, the flame retardant is BPADP, used alone or in combination with another flame retardant.

In another embodiment, the flame retardant comprises BPADP, MPP, and aluminum tris(diethyl phosphinate) (AIP). In this and other embodiments, approximately 8 to 12 weight percent of BPADP, 3 to 7 weight percent of MPP, and 3 to 7 weight percent of AIP are present, based on the total weight of the composition. More particularly, approximately 9 to 11 weight percent of BPADP, 4 to 6 weight percent of MPP, and 4 to 6 weight percent of AIP are present, based on the total weight of the composition.

In another embodiment, the flame retardant comprises BPADP, MPP, and Mg(OH)₂. In this and other embodiments, approximately 8 to 12 weight percent of BPADP, 2.5 to 7.5 weight percent of MPP, and 2.5 to 5 weight percent of Mg(OH)₂ are present, based on the total weight of the composition. More particularly, approximately 9 to 11 weight percent of BPADP, 3 to 7.0 weight percent of MPP, and 3 to 4.5 weight percent of Mg(OH)₂ are present, based on the total weight of the composition.

In another embodiment, the flame retardant comprises MPP alone or in combination with aluminum tris(diethyl phosphinate) (AIP). In this and other embodiments, approximately 5 to 10 weight percent of BPADP, and 5 to 10 weight percent of AIP are present, based on the total weight of the composition. More particularly, approximately 6 to 9 weight percent of MPP and 6 to 9 weight percent of AIP are present, based on the total weight of the composition.

In another embodiment, the composition optionally comprises an anti-UV agent. The anti-UV agent can be any of the UV agents disclosed herein, used alone or in combination. In this and other embodiments, the anti-UV agent or mixture of anti-UV agents is present in an amount of 0.1 to 5.0 weight percent based on the total weight of the composition.

In one embodiment, the anti-UV agent is a benzotriazole-type anti-UV agent such as Tinuvin 234, used alone or in combination with another anti-UV agent. In one embodiment, the anti-UV agent is a benzotriazole-type anti-UV agent such as Tinuvin 234, which is present in an amount of 0.5 to 1.0 weight percent, based on the total weight of the composition.

In another embodiment, the anti-UV agent is a cycloaliphatic epoxy compound or a hindered amine light stabilizer. In one embodiment, the cycloaliphatic epoxy compound is Celloxide 2021. In one embodiment 0.2 weight percent to 0.7 weight percent of Celloxide 2021 is present, based on the total weight of the composition.

In another embodiment, the anti-UV agent is a hindered amine light stabilizer (HALS). In one embodiment, the HALS is Uvinul 5050H. In one embodiment 0.5 weight percent to 2 weight percent of Uvinul 5050H is present, based on the total weight of the composition.

In another embodiment, the composition comprises a mixture of anti-UV agents. In one embodiment, the mixture of anti-UV agent comprises a benzotriazole-type UV agent, a HALS, and a cycloaliphatic epoxy compound, present in 0.5-3 weight percent based on the total weight of the composition.

In another embodiment, the jacketing composition comprises:
(a) 20 to 35 weight percent of poly(2,6-dimethyl-1,4-phenylene ether) having an intrinsic viscosity of 0.4 to 0.5 deciliter per gram measured in chloroform at 25° C.;
(b) 25 to 45 weight percent of a hydrogenated block copolymer of an alkenyl aromatic compound and a conjugated diene;
(c) 4 to 10 percent of a polyolefin homopolymer;
(d) 5 to 10 weight percent of a polybutene; and
(e) 10 to 30 weight percent of a flame retardant.

In another embodiment, the jacketing composition comprises:
(a) 20 to 35 weight percent of poly(2,6-dimethyl-1,4-phenylene ether) having an intrinsic viscosity of 0.4 to 0.5 deciliter per gram measured in chloroform at 25° C.;
(b) 25 to 45 weight percent of a mixture of the polystyrene-poly(ethylene-butylene-styrene)-polystyrene (SEBS) triblock copolymer (such as Kraton A1535 or A1536); and either of a melt-kneaded blend (such as TPE-SB2400 from Sumitomo Chemical) or a linear triblock copolymer based on styrene and ethylene/butylene, SEBS, with bound styrene of 30% mass, (such as Kraton G1652);
(c) 4 to 10 percent of a polyolefin homopolymer;
(d) 5 to 10 weight percent of a polybutene; and
(e) 10 to 30 weight percent of a flame retardant.

In another embodiment, the jacketing composition comprises:
(a) 20 to 35 weight percent of poly(2,6-dimethyl-1,4-phenylene ether) having an intrinsic viscosity of 0.4 to 0.5 deciliter per gram measured in chloroform at 25° C.;
(b) 25 to 45 weight percent of a mixture of the polystyrene-poly(ethylene-butylene-styrene)-polystyrene (SEBS) triblock copolymer (such as Kraton A1535 or A1536); and either of a melt-kneaded blend (such as TPE-SB2400 from Sumitomo Chemical) or a linear triblock copolymer based on styrene and ethylene/butylene, SEBS, with bound styrene of 30% mass, (such as Kraton G1652);
(c) 4 to 10 percent of propylene homopolymer;
(d) 5 to 10 weight percent of a polybutene; and
(e) 10 to 30 weight percent of a flame retardant.

In another embodiment, the jacketing composition comprises:
(a) 20 to 30 weight percent of poly(2,6-dimethyl-1,4-phenylene ether) having an intrinsic viscosity of 0.4 to 0.5 deciliter per gram measured in chloroform at 25° C.;
(b) 25 to 45 weight percent of a mixture of the polystyrene-poly(ethylene-butylene-styrene)-polystyrene (SEBS) triblock copolymer (such as Kraton A1535 or A1536); and either of a melt-kneaded blend (such as TPE-SB2400 from Sumitomo Chemical) or a linear triblock copolymer based on styrene and ethylene/butylene, SEBS, with bound styrene of 30% mass, (such as Kraton G1652);
(c) 4 to 10 percent of propylene homopolymer;
(d) 5 to 10 weight percent of a polyisobutene; and
(e) 10 to 30 weight percent of a flame retardant comprising, BPADP.

In another embodiment, the jacketing composition comprises:
(a) 20 to 35 weight percent of poly(2,6-dimethyl-1,4-phenylene ether) having an intrinsic viscosity of 0.4 to 0.5 deciliter per gram measured in chloroform at 25° C.;
(b) 25 to 45 weight percent of a mixture of the polystyrene-poly(ethylene-butylene-styrene)-polystyrene (SEBS) triblock copolymer (such as Kraton A1535 or A1536); and either of a melt-kneaded blend (such as TPE-SB2400 from Sumitomo Chemical) or a linear triblock copolymer based on styrene and ethylene/butylene, SEBS, with bound styrene of 30% mass, (such as Kraton G1652);
(c) 4 to 10 percent of propylene homopolymer;
(d) 5 to 10 weight percent of a polyisobutene; and
(e) 10 to 30 weight percent of a flame retardant comprising, BPADP and MPP.

In another embodiment, the jacketing composition comprises:
(a) 20 to 35 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a mixture of the polystyrene-poly(ethylene-butylene-styrene)-polystyrene (SEBS) triblock copolymer (such as Kraton A1535 or A1536); and either of a melt-kneaded blend (such as TPE-SB2400 from Sumitomo Chemical) or a linear triblock copolymer based on styrene and ethylene/butylene, SEBS, with bound styrene of 30% mass, (such as Kraton G1652);
(c) 4 to 10 percent of propylene homopolymer;
(d) 5 to 10 weight percent of a polyisobutene; and
(e) 10 to 30 weight percent of a flame retardant comprising, BPADP alone or in combination with one or both of MPP and aluminum tris(diethyl phosphinate).

In another embodiment, the jacketing composition comprises:
(a) 20 to 25 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer; and either of
   (b2) 10 to 18 weight percent of a melt kneaded blend comprising hydrogenated block copolymer, an ethylene-propylene copolymer, and mineral oil; or
   (b3) 6 to 16 weight percent of a linear triblock copolymer based on styrene and ethylene/butylene, SEBS, with bound styrene of 30% mass, (such as Kraton G1652);
(c) 4 to 8 percent of propylene homopolymer;
(d) 5 to 10 weight percent of a polyisobutene; and
(e) 10 to 30 weight percent of a flame retardant comprising,
   (e1) 8 to 12 weight percent of BPADP
   (e2) 3 to 7 weight percent MPP; and
   (e3) 3 to 7 weight percent aluminum tris(diethyl phosphinate).

In another embodiment, the jacketing composition comprises:
(a) 20 to 25 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer; and either of
   (b2) 10 to 18 weight percent of a melt kneaded blend comprising hydrogenated block copolymer, an ethylene-propylene copolymer, and mineral oil; or
   (b3) 6 to 16 weight percent of a linear triblock copolymer based on styrene and ethylene/butylene, SEBS, with bound styrene of 30% mass, (such as Kraton G1652);
(c) 4 to 8 percent of propylene homopolymer;
(d) 5 to 10 weight percent of a polyisobutene; and
(e) 10 to 30 weight percent of a flame retardant comprising,
   (e1) 9 to 11 weight percent of BPADP
   (e2) 4 to 6 weight percent MPP; and
   (e3) 4 to 6 weight percent aluminum tris(diethyl phosphinate).

In another embodiment, the jacketing composition comprises:
(a) 20 to 25 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer;
   (b2) 10 to 18 weight percent of a melt kneaded blend comprising hydrogenated block copolymer, an ethylene-propylene copolymer, and mineral oil;
(c) 4 to 8 percent of propylene homopolymer;
(d) 5 to 10 weight percent of a polyisobutene; and
(e) 15 to 25 weight percent of a flame retardant comprising,
   (e1) 9 to 11 weight percent of BPADP
   (e2) 4 to 6 weight percent MPP; and
   (e3) 4 to 6 weight percent aluminum tris(diethyl phosphinate).

In another embodiment, the jacketing composition comprises:
(a) 20 to 25 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer;
   (b2) 10 to 18 weight percent of a melt kneaded blend comprising hydrogenated block copolymer, an ethylene-propylene copolymer, and mineral oil;
(c) 4 to 8 percent of propylene homopolymer;
(d) 5 to 10 weight percent of a polyisobutene; and
(e) 10 to 30 weight percent of a flame retardant comprising,
   (e1) 9 to 11 weight percent of BPADP
   (e2) 4 to 6 weight percent MPP;
   (e3) 4 to 6 weight percent aluminum tris(diethyl phosphinate); and
(f) 0.1 to 2 weight percent of a colorant.

In this and other embodiments, the colorant is selected from the group consisting of TiO₂, carbon black, pigment blue 29, pigment yellow 119, pigment red 101, or combinations thereof. In this and other embodiments, the colorant comprises TiO₂, carbon black, pigment blue 29, pigment yellow 119, and pigment red 101.

In another embodiment, the jacketing composition comprises:
(a) 20 to 25 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer;
   (b2) 10 to 18 weight percent of a melt kneaded blend comprising hydrogenated block copolymer, an ethylene-propylene copolymer, and mineral oil;
(c) 4 to 8 percent of propylene homopolymer;
(d) 5 to 10 weight percent of a polyisobutene; and
(e) 10 to 30 weight percent of a flame retardant comprising,
   (e1) 8 to 12 weight percent of BPADP
   (e2) 3 to 7 weight percent MPP;
   (e3) 3 to 7 weight percent aluminum tris(diethyl phosphinate); and
(f) 0.1 to 2 weight percent of a colorant comprising a mixture of TiO₂, carbon black, pigment blue 29, pigment yellow 119, and pigment red 101;
(g) 0.8 to 1.2 percent of an antioxidant; and
(h) 1 to 2 weight percent of an anti-UV agent.

In another embodiment, the jacketing composition comprises:
(a) 20 to 35 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a polystyrene-poly(ethylene-butylene-styrene)-polystyrene (SEBS) triblock copolymer and a melt kneaded blend comprising hydrogenated block copolymer, an ethylene-propylene copolymer, and mineral oil;
(c) 4 to 8 percent of a propylene homopolymer;
(d) 5 to 10 weight percent of a polyisobutene; and
(e) 10 to 30 weight percent of a flame retardant comprising, BPADP alone or in combination with one or both of MPP and Mg(OH)₂.

In another embodiment, the jacketing composition comprises:
(a) 20 to 25 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer;
   (b2) 10 to 18 weight percent of a melt kneaded blend comprising hydrogenated block copolymer, an ethylene-propylene copolymer, and mineral oil; or
   (b3) 8 to 16 weight percent of a linear triblock copolymer based on styrene and ethylene/butylene, SEBS, with bound styrene of 30% mass, (such as Kraton G1652);
(c) 4 to 8 percent of propylene homopolymer;
(d) 5 to 10 weight percent of a polyisobutene; and
(e) 10 to 30 weight percent of a flame retardant comprising,
   (e1) 8 to 12 weight percent of BPADP
   (e2) 2.5 to 7.5 weight percent MPP; and
   (e3) 2.5 to 5 weight percent Mg(OH)₂.

In another embodiment, the jacketing composition comprises:
(a) 20 to 25 weight percent of poly(2,6-dimethyl-1,4-phenylene ether) having an intrinsic viscosity of 0.4 to 0.5 deciliter per gram measured in chloroform at 25° C.;
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer;
   (b2) 10 to 18 weight percent of a melt kneaded blend comprising hydrogenated block copolymer, an ethylene-propylene copolymer, and mineral oil; or
(c) 4 to 8 percent of propylene homopolymer;
(d) 5 to 10 weight percent of a polyisobutene; and
(e) 10 to 30 weight percent of a flame retardant comprising,
   (e1) 8 to 12 weight percent of BPADP
   (e2) 3 to 7 weight percent MPP; and
   (e3) 3 to 4.5 weight percent Mg(OH)₂.

In another embodiment, the jacketing composition comprises:
(a) 20 to 25 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer;
   (b2) 10 to 18 weight percent of a melt kneaded blend comprising hydrogenated block copolymer, an ethylene-propylene copolymer, and mineral oil;
(c) 4 to 8 percent of propylene homopolymer;
(d) 5 to 10 weight percent of a polyisobutene; and
(e) 10 to 30 weight percent of a flame retardant comprising,
   (e1) 8 to 12 weight percent of BPADP
   (e2) 3 to 7 weight percent MPP; and
   (e3) 3 to 4.5 weight percent Mg(OH)₂; and
(f) 0.1 to 2 weight percent of a colorant.

In this and other embodiments, the colorant is selected from the group consisting of TiO₂, carbon black, pigment blue 29, pigment yellow 119, pigment red 101, or combinations thereof. In this and other embodiments, the colorant comprises TiO₂, pigment blue 29, and pigment red 101.

In another embodiment, the jacketing composition comprises:
(a) 20 to 25 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer;
   (b2) 10 to 18 weight percent of a melt kneaded blend comprising hydrogenated block copolymer, an ethylene-propylene copolymer, and mineral oil;
(c) 4 to 8 percent of propylene homopolymer;
(d) 5 to 10 weight percent of a polyisobutene; and
(e) 10 to 30 weight percent of a flame retardant comprising,
   (e1) 8 to 12 weight percent of BPADP
   (e2) 3 to 7 weight percent MPP; and
   (e3) 3 to 4.5 weight percent Mg(OH)₂;
(f) 0.1 to 2 weight percent of a colorant comprising a mixture of TiO2, pigment blue 29, and pigment red 101;
(g) 0.8 to 1.2 percent of an antioxidant; and
(h) 1 to 2 weight percent of an anti-UV agent.

In another embodiment, the jacketing composition comprises:
(a) 20 to 35 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a polystyrene-poly(ethylene-butylene-styrene)-polystyrene (SEBS) triblock copolymer and a linear triblock copolymer based on styrene and ethylene/butylene, SEBS;
(e) 4 to 8 percent of propylene homopolymer;
(d) 5 to 10 weight percent of a polyisobutene; and
(e) 10 to 30 weight percent of a flame retardant comprising, MPP alone or in combination with aluminum tris(diethyl phosphinate).

In another embodiment, the jacketing composition comprises:
(a) 20 to 35 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer;
   (b2) 10 to 18 weight percent of a melt kneaded blend comprising hydrogenated block copolymer, an ethylene-propylene copolymer, and mineral oil; or
   (b3) 8 to 16 weight percent of a linear triblock copolymer based on styrene and ethylene/butylene, SEBS, with bound styrene of 30% mass, (such as Kraton G1652);
(c) 4 to 8 percent of propylene homopolymer;
(d) 5 to 10 weight percent of a polyisobutene; and
(e) 10 to 30 weight percent of a flame retardant comprising,
   (e1) 5 to 10 weight percent of MPP; and
   (e2) 5 to 10 weight percent of AIP.

In another embodiment, the jacketing composition comprises:
(a) 30 to 35 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer;
   (b2) 6 to 12 weight percent of a melt kneaded blend comprising hydrogenated block copolymer, an ethylene-propylene copolymer, and mineral oil; and
(c) 4 to 8 percent of propylene homopolymer;
(d) 5 to 10 weight percent of a polyisobutene; and
(e) 10 to 30 weight percent of a flame retardant comprising, 10 to 30 weight percent of a flame retardant comprising,
   (e1) 6 to 9 weight percent of MPP; and
   (e2) 6 to 9 weight percent of AIP.

In another embodiment, the jacketing composition comprises:
(a) 20 to 25 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer;
   (b2) 10 to 18 weight percent of a melt kneaded blend comprising hydrogenated block copolymer, an ethylene-propylene copolymer, and mineral oil;
(c) 4 to 8 percent of propylene homopolymer;
(d) 5 to 10 weight percent of a polyisobutene; and
(e) 10 to 30 weight percent of a flame retardant comprising,
   (e1) 6 to 9 weight percent of MPP;
   (e2) 6 to 9 weight percent of AIP; and
(f) 0.1 to 2 weight percent of a colorant.

In this and other embodiments, the colorant is selected from the group consisting of TiO₂, carbon black, pigment blue 29, pigment yellow 119, pigment red 101, or combinations thereof. In this and other embodiments, the colorant comprises TiO₂, pigment blue 29, and pigment red 101.

In another embodiment, the jacketing composition comprises:
(a) 20 to 25 weight percent of poly(2,6-dimethyl-1,4-phenylene ether) having an intrinsic viscosity of 0.4 to 0.5 deciliter per gram measured in chloroform at 25° C.
(b) 25 to 45 weight percent of a hydrogenated block copolymer, comprising:
   (b1) 20 to 28 weight percent of a polystyrene-poly(ethylene-butylene-styrene)-polystyrene (SEBS) triblock copolymer;
   (b2) 10 to 18 weight percent of a melt kneaded blend comprising hydrogenated block copolymer, an ethylene-propylene copolymer, and mineral oil;
(c) 4 to 8 percent of propylene homopolymer;
(d) 5 to 10 weight percent of a polyisobutene; and
(e) 10 to 30 weight percent of a flame retardant comprising,
   (e1) 6 to 9 weight percent of MPP;
   (e2) 6 to 9 weight percent of AIP;
(f) 0.1 to 2 weight percent of a colorant comprising a mixture of TiO2, pigment blue 29, and pigment red 101;
(g) 0.8 to 1.2 percent of an antioxidant; and
(h) 1 to 2 weight percent of an anti-UV agent.

In another embodiment, the jacketing composition is as described in Examples 2, 3, 5, 6, 7, 8, and 9 of Table 5.

### Process and Articles

In another aspect, the invention provides a process for jacketing an electrical cable or plug. The process comprises extrusion coating an electrical cable or plug with a jacketing composition as described in the previous embodiments.

In another aspect, the invention provides an extrusion coated article comprising the jacketing composition as described in the previous embodiments.

In another aspect, the invention provides an injection molded article comprising the jacketing composition as described in the previous embodiments.

The following examples illustrate the scope of the invention. The examples and preparations which follow are provided to enable those skilled in the art to more clearly understand and to practice the present invention. They should not be considered as limiting the scope of the invention, but merely as being illustrative and representative thereof.

### EXAMPLES

The examples of the jacketing compositions of the present invention, annotated hereinafter as “Ex.” And their comparative examples, annotated hereinafter as “CE”, employed the materials listed in Table 1. All weight percents employed in the examples are based on the weight percent of the entire jacketing composition except where stated otherwise.

TABLE 1

| Component | Trade name and Supplier |
|---|---|
| PPE | Poly(2,6-dimethyl-1,4-phenylene ether), CAS Reg. No. 24938-67-8, having |
| | an intrinsic viscosity of 0.46 deciliters per gram, measured in chloroform at |
| | 25° C., and obtained as PPO 646 resin from SABIC Innovative Plastics |
| | (“0.46 IV PPE”). |
| SEBS-I | A linear triblock polystyrene-poly(ethylene-butylene)-polystyrene |
| | copolymer, having a polystyrene count of about 37 to 44 weight percent and |
| | a number average molecular weight of 160,000 atomic mass units, supplied |
| | as an undusted powder from Kraton Performance Polymers, Inc. as A1536 |
| | HU and A1536 HS |
| SEBS-II | A linear triblock copolymer based on styrene and ethylene/butylene, SEBS, |
| | with bound styrene of 30% mass, available from SEBS, Kraton |
| | Performance Polymers, Inc. as G1652. |
| SEBS-III | A melt-kneaded blend comprising about 35 weight percent polystyrene- |
| | poly(ethylene-butylene)-polystyrene, about 20 weight percent ethylene- |
| | propylene rubber, and about 45 weight percent mineral oil, obtained as |
| | TPE-SB2400 from Sumitomo Chemical Co. (“SEBS SB2400”). |
| PIB | A liquid polybutene, specifically a polyisobutene, having a number average |
| | molecular weight of about 800 AMU, was obtained as Indopol H50 from |
| | INEOS Oligomers. |
| PP | Polypropylene homopolymer, CAS Reg. No. 9003-07-0, available from |
| | SABIC Innovative Plastics as 570P. |
| Mg(OH)₂ | Magnesium Hydroxide, CAS Reg. No. 9000-70-8, available from Kisuma |
| | Chemicals B.V. Industry as Kisuma 5A. |
| A1P | A flame retardant consisting of aluminum tris(diethyl phosphinate), |
| | available commercially from Clariant Corporation as EXOLIT OP 1230. |
| MPP | Melamine polyphosphate, CAS Reg. No. 218768-84-4, obtained from |
| | Budenheim as Budit 3141. |
| BPADP | Bisphenol A bis-diphenylphosphate, CAS Reg. No. 181028-79-5, |
| | commercially available from DAIHACHI Chemical Industry Co., Ltd. |
| | Under the tradename of CR741. |
| Tinuvin 234 | 2-(2H-benzotriazol-2-yl)-4,6-bis(1-methyl-1-phenylethyl)phenol, CAS Reg. |
| | No. 70321-86-17, obtained from BASF Corporation. |
| AO-I | Stearyl-3-(3′5′-di-t-butyl-4-hydroxyphenyl) propionate, CAS Reg. No. |
| | 2082-79-3, commercially available under the tradename Irganox 1076 from |
| | BASF Corporation. |
| AO-II | Tetrakis(2,4-di-tert-butylphenyl)-4,4-biphenyldiphosphonite, CAS Reg. No. |
| | 38613-77-3, commercially available under the trade name of Hostanox P- |
| | EPQ from Clariant Corporation. |
| MD | 2′,3-bis[[3-[3,5-di-tert-butyl-4-hydroxyphenyl]propionyl] |
| | propionohydrazide, CAS Reg. No. 32687-78-8, commercially available |
| | under the tradename Irganox MD 1024 from BASF Corporation. |
| MgO | Magnesium oxide, CAS Reg. No. 1309-48-4, commercially available under |
| | the brand name Kyowa Mag from Kyowa Chemical Industry Co. Ltd. |
| ZnS | Zinc sulfide, CAS Reg. No. 1314-98-3, was obtained from Sachtleben |
| | Chemie GmbH as Sachtolith HD. |
| Erucamide | Erucamide, CAS Reg. No. 112-84-5, was obtained from Crompton |
| | Corporation as Kemamide E Ultra. |
| Fragrance | A polyethylene-encapsulated fragrance obtained from International Flavors |
| | and Fragrances, Inc. as IFI-7191 PBD. |
| Celloxide | (3′-4′-Epoxycyclohexane)methyl 3′-4′-epoxycyclohexyl-carboxylate, CAS |
| | Reg. No. 2386-87-0 obtained from Daicel Corporation as Celloxide 2021P |
| Tinuvin 234 | 2-(2H-benzotriazol-2-yl)-4,6-bis(1-methyl-1-phenylethyl)phenol, CAS Reg. |
| | No. 70321-86-17, obtained from BASF. |
| TiO₂-I | Titanium dioxide having an average particle size of 0.2 micrometers was |
| | obtained from Huntsman Corporation as Tioxide R-FC5. |
| TiO₂-II | Titanium dioxide having an average particle size of 0.2 micrometers was |
| | obtained from Huntsman as TIOXIDE R-TC30. |
| Carbon Black | Carbon black having an iodine absorption of 231 grams per kilogram |
| | determined according to ASTM D1510-02a was obtained from Cabot |
| | Corporation as Monarch 800. |
| Pigment Blue | Na₆Al₄Si₆S₄O₂₀ (Ultramarine Blue), CAS Reg. No. 57455-37-5, obtained as |
| 29 | Ultramarine 5085 from Holiday Pigments Ltd. |
| Pigment | Fe₂O₃•ZnO (Zinc Ferrite Tan or Brown), CAS Reg. No. 68187-51-9, |
| Yellow 119 | obtained as Mapico Tan 10A from Rockwood Pigments NA, Inc. |
| Pigment Red | Fe₂O₃ (Ferric Oxide), CAS Reg. No. 1309-37-1, obtained as ColorTherm |
| 101 | Red 180M from Lanxess Inorganic Pigments |

### Method

The jacketing compositions and comparative examples were prepared by compounding on a 37 mm Toshiba SE twin screw extruder (Toshiba TSE 37BS) as summarized in Table 2.

TABLE 2
Compounding profile on Toshiba TEM-37BS

| Parameters | Unit | Set Values |
|---|---|---|
| Zone 1 Temp | ° C. | 50 |
| Zone 2 Temp | ° C. | 180 |
| Zone 3 Temp | ° C. | 225 |
| Zone 4 Temp | ° C. | 245 |
| Zone 5 Temp | ° C. | 245 |
| Zone 6 Temp | ° C. | 245 |
| Zone 7 Temp | ° C. | 245 |
| Zone 8 Temp | ° C. | 245 |
| Zone 9 Temp | ° C. | 245 |
| Zone 10 Temp | ° C. | 245 |
| Zone 11 Temp | ° C. | 245 |
| Die Temp | ° C. | 255 |
| Screw speed | rpm | 400 |
| Throughput | kg/hr | 35 |

Cable Extrusion:

The cable samples were extruded on WTL EXL50 with melt temperature at 240 C without pre-heating. The line speed was set at 20 m/min. The cable configuration was cable with outer diameter of 5.2 mm and core diameter of 3.5 mm.

### Testing

Wrinkle Performance:

The cable samples were bent and checked for wrinkles on the cable surface. Results were recorded as “serious wrinkling,” “some wrinkling,” and almost no wrinkling.” “Serious wrinkling (+)” means that there was substantial wrinkling in the jacketing compositions. “Some wrinkling (++)” means that wrinkling was readily noticeable to the observer. “Almost no wrinkling (+++)” means that very little wrinkling was noticeable to the observer.

### Results

Table 3 summarizes the testing results. The formulations varied in terms of PP loading, from 0 weight percent (Comparative Example 1) to approximately 2 weight percent (Example 3), 5 weight percent (Examples 5 and 7) and 7-8 weight percent (Examples 3, 6, 8, and 9). The samples were evaluated for wrinkling upon bending and the samples were scored for wrinkling as provided above.

When PP loading was less than 2 percent wrinkling was serious (Examples 1 and 4). When PP loading was increased to about 5 percent, there were still some wrinkles on the bent cable (Examples 2, 5, and 7), but the appearance was much better than that with jacketing compositions containing less than 2 weight percent (Comparator Examples 1 and 4). Finally, there were almost no wrinkles on the surface of bent cables when the PP loading was increased to about 7-8 weight percent (Examples 3, 6, 8, and 9).

The Table 3 data also indicates that compositions may contain a range of colorants (Examples 2, 3, 5-8) or be colorant-free (Example 9), as long as PP loading was maintained at or above approximately 3 percent.

TABLE 5

| | EX1 | | | EX4 | | | | | |
|---|---|---|---|---|---|---|---|---|---|
| Raw Material | Comparator | EX2 | EX3 | Comparator | EX5 | EX6 | EX7 | EX8 | EX9 |
| PPE, 0.46IV | 25.234 | 21.682 | 21.662 | 21.094 | 21.094 | 21.094 | 33.138 | 33.138 | 22.34 |
| SEBS-I | 20.094 | 24.510 | 22.603 | 26.597 | 26.597 | 23.845 | 27.290 | 27.290 | 23.31 |
| SEBS-II | — | — | — | — | — | — | 10.721 | 7.797 | 15.54 |
| SEBS-1II | 15.888 | 16.026 | 15.069 | 15.591 | 12.840 | 12.840 | — | — | — |
| PP | — | 4.714 | 7.534 | 1.834 | 4.586 | 7.337 | 4.873 | 7.797 | 7.77 |
| PIB | 7.944 | 7.542 | 7.534 | 7.337 | 7.337 | 7.337 | 7.797 | 7.797 | 7.77 |
| Mg(OH)₂ | 5.608 | — | — | 3.668 | 3.668 | 3.668 | — | — | — |
| MPP | 9.346 | 4.714 | 4.709 | 6.420 | 6.420 | 6.420 | 6.823 | 6.823 | 4.86 |
| BPADP | 9.346 | 10.372 | 10.361 | 9.171 | 9.171 | 9.171 | — | — | 10.69 |
| AIP | — | 4.714 | 4.709 | — | — | — | 6.823 | 6.823 | 5.08 |
| AO-I | 0.701 | 0.707 | 0.706 | 0.688 | 0.688 | 0.688 | 0.731 | 0.731 | 0.73 |
| AO-II | 0.075 | 0.236 | 0.236 | 0.229 | 0.229 | 0.229 | 0.244 | 0.244 | — |
| MD | 0.093 | 0.094 | 0.094 | 0.092 | 0.092 | 0.092 | 0.097 | 0.097 | 0.10 |
| MgO | 0.140 | — | — | 0.138 | 0.138 | 0.138 | — | — | — |
| ZnS | 0.140 | — | — | 0.138 | 0.138 | 0.138 | — | — | 0.29 |
| Erucamide | 0.467 | 0.188 | 0.282 | 0.183 | 0.183 | 0.183 | 0.487 | 0.487 | 0.06 |
| Fragrance | 0.056 | 0.056 | 0.056 | 0.055 | 0.055 | 0.055 | — | — | — |
| Celloxide | 0.308 | 0.471 | 0.471 | 0.303 | 0.303 | 0.303 | — | — | 0.49 |
| Tinuvin 234 | 0.701 | 0.943 | 0.942 | 0.688 | 0.688 | 0.688 | — | — | 0.97 |
| Uvinul 5050H | 0.935 | — | — | 0.917 | 0.917 | 0.917 | — | — | — |
| TiO2-I | 2.804 | 2.909 | 2.909 | — | — | — | — | — | — |
| TiO2-II | — | — | — | 4.769 | 4.769 | 4.769 | — | — | — |
| Carbon Black | 0.026 | 0.027 | 0.027 | — | — | — | 0.975 | 0.975 | — |
| Pigment Blue 29 | 0.047 | 0.048 | 0.048 | 0.060 | 0.060 | 0.060 | — | — | — |
| Pigment Yellow 119 | 0.028 | 0.029 | 0.029 | — | — | — | — | — | — |
| Pigment Red 101 | 0.019 | 0.019 | 0.019 | 0.029 | 0.029 | 0.029 | — | — | — |
| Wrinkle | + | ++ | +++ | + | ++ | +++ | ++ | +++ | +++ |
| Performance | | | | | | | | | |

The foregoing invention has been described in some detail by way of illustration and example for purposes of clarity and understanding. The invention has been described with reference to various specific embodiments and techniques. It should be understood that many variations and modifications may be made while remaining within the spirit and scope of the invention. It will be obvious to one of skill in the art that changes and modifications may be practiced within the scope of the appended claims. The above description is intended to be illustrative and not restrictive.

1. A cable jacketing composition, comprising:
(a) 20 to 40 weight percent of a poly(phenylene ether);
(b) 25 to 50 weight percent of a hydrogenated block copolymer of an alkenyl aromatic compound and a conjugated diene;
(c) 3 to 15 percent of a polyolefin homopolymer;
(d) 5 to 15 weight percent of a polybutene; and
(e) 10 to 47 weight percent of a flame retardant; and
wherein the weight percents are based on the total weight of the composition.

2. The cable jacketing composition of claim 1, wherein the poly(phenylene ether) is a poly (2,6-dimethyl-1,4-phenylene ether having an intrinsic viscosity of 0.3 to 0.6 deciliter per gram measured in chloroform at 25° C.

3. The cable jacketing composition of claim 2, wherein the hydrogenated block copolymer of an alkenyl aromatic compound and a conjugated diene comprises a polystyrene-poly(ethylene-butylene-styrene)-polystyrene (SEBS) triblock copolymer.

4. The cable jacketing composition of claim 3, wherein the polyolefin homopolymer is propylene homopolymer.

5. The cable jacketing composition of claim 4, wherein 4-8 weight percent of the polypropylene homopolymer are used based in the total weight of the composition.

6. The cable jacketing composition of claim 5, wherein the polybutene is a liquid polyisobutene.

7. The cable jacketing composition of claim 6, wherein the flame retardant is selected from the group consisting of a phosphate ester, a hydroxide salt, and a phosphinate salt, used alone or in combination with one or more other flame retardants.

8. The jacketing composition of claim 7, wherein the flame retardant is selected from the group consisting of BPADP, melamine polyphosphate, magnesium hydroxide, and aluminum tris(diethyl phosphinate), used alone or in combination with one or more other flame retardants.

9. The cable jacketing composition of claim 8, wherein the hydrogenated block copolymer of an alkenyl aromatic compound and a conjugated diene comprises a polystyrene-poly(ethylene-butylene-styrene)-polystyrene (SEBS) triblock copolymer and a melt kneaded blend comprising hydrogenated block copolymer, an ethylene-propylene copolymer, and mineral oil or a linear triblock copolymer based on styrene and ethylene/butylene, SEBS.

10. The jacketing composition of claim 8 or 9, optionally comprising 0.1 to 5 percent of an anti-UV agent selected from the group consisting of benzotriazole-type anti-UV absorbers, triazine-type UV absorbers, cycloaliphatic UV stabilizers, and hindered amine light stabilizers.

11. The composition of claim 1, comprising:
(a) 20 to 35 weight percent of poly(2,6-dimethyl-1,4-phenylene ether having an intrinsic viscosity of 0.4 to 0.5 deciliter per gram measured in chloroform at 25° C.
(b) 25 to 45 weight percent of a polystyrene-poly(ethylene-butylene-styrene)-polystyrene (SEBS) triblock copolymer and a melt kneaded blend comprising hydrogenated block copolymer, an ethylene-propylene copolymer, and mineral oil;
(c) 3 to 10 percent of a polyolefin homopolymer;
(d) 5 to 10 weight percent of a polyisobutene; and
(e) 10 to 30 weight percent of a flame retardant.

12. The composition of claim 11, comprising:
(a) 20 to 35 weight percent of poly(2,6-dimethyl-1,4-phenylene ether having an intrinsic viscosity of 0.4 to 0.5 deciliter per gram measured in chloroform at 25° C.
(b) 25 to 45 weight percent of a polystyrene-poly(ethylene-butylene-styrene)-polystyrene (SEBS) triblock copolymer and a melt kneaded blend comprising hydrogenated block copolymer, an ethylene-propylene copolymer, and mineral oil;
(c) 3 to 10 percent of propylene homopolymer;
(d) 5 to 10 weight percent of a polyisobutene; and
(e) 10 to 30 weight percent of a flame retardant comprising, BPADP alone or in combination with one or both of MPP and aluminum tris(diethyl phosphinate).

13. The composition of claim 12, comprising:
(a) 20 to 35 weight percent of poly(2,6-dimethyl-1,4-phenylene ether having an intrinsic viscosity of 0.4 to 0.5 deciliter per gram measured in chloroform at 25° C.
(b) 25 to 45 weight percent of a hydrogenated block copolymer, comprising:
(b1) 20 to 28 weight percent of a polystyrene-poly(ethylene-butylene-styrene)-polystyrene (SEBS) triblock copolymer;
(b2) 10 to 18 weight percent of a melt kneaded blend comprising hydrogenated block copolymer, an ethylene-propylene copolymer, and mineral oil; or
(b3) 8 to 16 weight percent of a linear triblock copolymer based on styrene and ethylene/butylene, SEBS, with bound styrene of 30% mass, (such as Kraton G1652);
(c) 4 to 8 percent of propylene homopolymer;
(d) 5 to 10 weight percent of a polyisobutene; and
(e) 10 to 30 weight percent of a flame retardant comprising,
(e1) 8 to 12 weight percent of BPADP
(e2) 3 to 7 weight percent MPP; and
(e3) 3 to 7 weight percent aluminum tris(diethyl phosphinate).

14. The composition of claim 12, comprising:
(a) 20 to 35 weight percent of poly(2,6-dimethyl-1,4-phenylene ether having an intrinsic viscosity of 0.4 to 0.5 deciliter per gram measured in chloroform at 25° C.
(b) 25 to 45 weight percent of a hydrogenated block copolymer, comprising:
(b1) 20 to 28 weight percent of a polystyrene-poly(ethylene-butylene-styrene)-polystyrene (SEBS) triblock copolymer;
(b2) 10 to 18 weight percent of a melt kneaded blend comprising hydrogenated block copolymer, an ethylene-propylene copolymer, and mineral oil; or
(b3) 6 to 16 weight percent of a linear triblock copolymer based on styrene and ethylene/butylene, SEBS, with bound styrene of 30% mass, (such as Kraton G1652);
(c) 4 to 8 percent of propylene homopolymer;
(d) 5 to 10 weight percent of a polyisobutene; and
(e) 15 to 25 weight percent of a flame retardant comprising,
(e1) 9 to 11 weight percent of BPADP
(e2) 4 to 6 weight percent MPP; and
(e3) 4 to 6 weight percent aluminum tris(diethyl phosphinate).

15. The composition of claim 11, comprising:
(a) 20 to 35 weight percent of poly(2,6-dimethyl-1,4-phenylene ether having an intrinsic viscosity of 0.4 to 0.5 deciliter per gram measured in chloroform at 25° C.
(b) 25 to 45 weight percent of a polystyrene-poly(ethylene-butylene-styrene)-polystyrene (SEBS) triblock copolymer and a melt kneaded blend comprising hydrogenated block copolymer, an ethylene-propylene copolymer, and mineral oil;
(c) 4 to 8 percent of propylene homopolymer;
(d) 5 to 10 weight percent of a polyisobutene; and
(e) 10 to 30 weight percent of a flame retardant comprising, BPADP alone or in combination with one or both of MPP and Mg(OH)₂.

16. The composition of claim 15, comprising:
(a) 20 to 25 weight percent of poly(2,6-dimethyl-1,4-phenylene ether having an intrinsic viscosity of 0.4 to 0.5 deciliter per gram measured in chloroform at 25° C.
(b) 25 to 45 weight percent of a hydrogenated block copolymer, comprising:
(b1) 20 to 28 weight percent of a polystyrene-poly(ethylene-butylene-styrene)-polystyrene (SEBS) triblock copolymer;
(b2) 10 to 18 weight percent of a melt kneaded blend comprising hydrogenated block copolymer, an ethylene-propylene copolymer, and mineral oil; or
(b3) 6 to 16 weight percent of a linear triblock copolymer based on styrene and ethylene/butylene, SEBS, with bound styrene of 30% mass, (such as Kraton G1652);
(c) 4 to 8 percent of propylene homopolymer;
(d) 5 to 10 weight percent of a polyisobutene; and
(e) 10 to 30 weight percent of a flame retardant comprising,
(e1) 8 to 12 weight percent of BPADP
(e2) 2.5 to 7.5 weight percent MPP; and
(e3) 2.5 to 5 weight percent Mg(OH)₂.

17. The composition of claim 16, comprising:
(a) 20 to 25 weight percent of poly(2,6-dimethyl-1,4-phenylene ether having an intrinsic viscosity of 0.4 to 0.5 deciliter per gram measured in chloroform at 25° C.
(b) 25 to 45 weight percent of a hydrogenated block copolymer, comprising:
(b1) 20 to 28 weight percent of a polystyrene-poly(ethylene-butylene-styrene)-polystyrene (SEBS) triblock copolymer;
(b2) 12 to 17 weight percent of a melt kneaded blend comprising hydrogenated block copolymer, an ethylene-propylene copolymer, and mineral oil; or
(c) 4 to 8 percent of propylene homopolymer;
(d) 5 to 10 weight percent of a polyisobutene; and
(e) 10 to 30 weight percent of a flame retardant comprising,
(e1) 9 to 11 weight percent of BPADP
(e2) 3 to 7 weight percent MPP; and
(e3) 3 to 4.5 weight percent Mg(OH)₂.

18. The composition of claim 11, comprising;
(a) 20 to 35 weight percent of poly(2,6-dimethyl-1,4-phenylene ether having an intrinsic viscosity of 0.4 to 0.5 deciliter per gram measured in chloroform at 25° C.
(b) 25 to 45 weight percent of a polystyrene-poly(ethylene-butylene-styrene)-polystyrene (SEBS) triblock copolymer and a linear triblock copolymer based on styrene and ethylene/butylene, SEBS;
(c) 4 to 8 percent of propylene homopolymer;
(d) 5 to 10 weight percent of a polyisobutene; and
(e) 10 to 30 weight percent of a flame retardant comprising, MPP alone or in combination with aluminum tris(diethyl phosphinate).

19. The composition of claim 18, comprising;
(a) 20 to 35 weight percent of poly(2,6-dimethyl-1,4-phenylene ether having an intrinsic viscosity of 0.4 to 0.5 deciliter per gram measured in chloroform at 25° C.
(b) 25 to 45 weight percent of a hydrogenated block copolymer, comprising:
(b1) 20 to 28 weight percent of a polystyrene-poly(ethylene-butylene-styrene)-polystyrene (SEBS) triblock copolymer;
(b2) 10 to 18 weight percent of a melt kneaded blend comprising hydrogenated block copolymer, an ethylene-propylene copolymer, and mineral oil; or
(b3) 6 to 16 weight percent of a linear triblock copolymer based on styrene and ethylene/butylene, SEBS, with bound styrene of 30% mass, (such as Kraton G1652);
(c) 4 to 8 percent of propylene homopolymer;
(d) 5 to 10 weight percent of a polyisobutene; and
(e) 10 to 30 weight percent of a flame retardant comprising,
(e1) 5 to 10 weight percent of MPP; and
(e2) 5 to 10 weight percent of AIP.

20. The composition of claim 19, comprising;
(a) 30 to 35 weight percent of poly(2,6-dimethyl-1,4-phenylene ether having an intrinsic viscosity of 0.4 to 0.5 deciliter per gram measured in chloroform at 25° C.
(b) 25 to 45 weight percent of a hydrogenated block copolymer, comprising:
(b1) 20 to 28 weight percent of a polystyrene-poly(ethylene-butylene-styrene)-polystyrene (SEBS) triblock copolymer;
(b2) 6 to 12 weight percent of a melt kneaded blend comprising hydrogenated block copolymer, an ethylene-propylene copolymer, and mineral oil; and
(c) 4 to 8 percent of propylene homopolymer;
(d) 5 to 10 weight percent of a polyisobutene; and
(e) 10 to 30 weight percent of a flame retardant comprising,
(e1) 6 to 9 weight percent of MPP; and
(e2) 6 to 9 weight percent of AIP.

21. An extrusion coated article comprising the jacketing composition of claim 1 or 11.

22. An injection molded article comprising the jacketing composition of claim 1 or 11.
